(19) United States
(12) Patent Application Publication
(10) Pub. No.: US 2007/0078821 A1
(43) Pub. Date: Apr. 5, 2007

(54) System and method for managing history of plant data

(75) Inventors: Takashi Kubo, Saitama-shi (JP); Tsuneo Watanabe, Inagi-shi (JP); Manabu Kataoka, Fuchu-shi (JP); Katsunori Kodama, Hino-shi (JP); Manabu Ikemoto, Fussa-shi (JP); Masaru Hirakawa, Nishitokyo-shi (JP)

Correspondence Address: FOLEY AND LARDNER LLP;SUITE 500, 3000 K STREET NW, WASHINGTON, DC, 20007, US

(73) Assignee: KABUSHIKI KAISHA TOSHIBA

(21) Appl. No.: 11/239,106

(22) Filed: Sep. 30, 2005

(51) Int. Cl. G06F 17/30

(52) U.S. Cl. 707/3

(57) ABSTRACT

A data server and a user terminal are connected through a communication network. A retrieval interface of the user terminal creates a retrieval request including specification of a file format style at the time of output, and transmits the created retrieval request to the data server. A data retrieval unit of the data server performs retrieval in a plant database and a point number information database based on the retrieval request, converts obtained retrieval result data into a file format style specified by the retrieval request, stores the converted data in a retrieval result database, and returns a response notification to the user terminal which has issued the request.

### BACKGROUND OF THE INVENTION

1. Field of the Invention

The present invention relates to a system which stores plant data as history data, executes retrieval of the plant data in accordance with a retrieval request from a user terminal and returns a result of the retrieval to the user terminal.

2. Description of the Related Art

Generally, in a supervisory control computer or a data collection apparatus which performs supervisory control over various kinds of plants such as an electric generating plant, plant data indicative of a state of each portion in a plant is periodically collected from a sensor or a measuring instrument attached to a device or an equipment of each portion in the plant or the device or equipment itself.

The periodically collected plant data is stored as history data in a data server, and saved for a long period in view of utilization in analysis, diagnosis or the like of the plant. Further, data concerning an operating state of the plant may be manually input from a business terminal by a person in charge of affairs in some cases, and such data is also stored as plant data in the data server and saved for a long time.

There has been recently proposed a history data management system configured to perform retrieval of plant data with respect to a data server having the plant data stored therein from a plurality of user terminals through a communication network (see, e.g., Jpn. Pat. Appln. KOKAI Publication No. 2002-82715). In this history data management system, the data server performs retrieval of plant data in response to a retrieval request from a user terminal, fetches data specified by a user, outputs the fetched data as retrieval result data indicative of a retrieval result, and returns it to the user terminal which has sent the request.

However, the above-described conventional history data management system has the following problems.

First, a man-machine interface mounted on a user terminal side is manufactured and delivered by a manufacturer, and it is not opened to users. Therefore, such an interface cannot be readily changed on the user side. Accordingly, when a user outputs retrieval result data indicative of a retrieval result of plant data in a user terminal, he/she can only output such data in a predetermined file format style such as a predetermined form format or a graph format in a screen, and cannot output it in any other format. When a user utilizes the retrieval result data in any other format, he/she must newly perform an operation of changing the format after the retrieval result data is output.

Further, in a case where the retrieval result data output in response to the retrieval request from the user terminal is saved separately from the plant data, since the man-machine interface is hard to be changed, the retrieval data can be output under a predetermined file name only in a predetermined save position, and it cannot be output in any other save position or under any other file name. Therefore, when a user saves the retrieval result data under a different file name in a different save position, the saved retrieval result data must be newly transferred to any other save position or its file name must be changed after the retrieval result data is output.

Furthermore, when a user wants to periodically acquire retrieval result data in order to perform periodic analysis, diagnosis or the like of plant data, the user must periodically request retrieval. In this case, it is necessary to newly perform a format changing operation, a save position changing operation, a file name changing operation or the like with respect to the retrieval result data saved in a predetermined file format style under a predetermined file name at a predetermined save position.

On the other hand, the man-machine interface in a conventional history data management system is manufactured by a manufacturer after making arrangements between a user and the manufacturer in such a manner that requested specifications are satisfied. However, creation of the man-machine interface in which all the specifications requested by the user are reflected is actually difficult in a restricted delivery period or budget. Therefore, a change or the like is often made to the specifications in accordance with a request from the user after constructing the history data management system. Nevertheless, creation of the man-machine interface which satisfies all the requests from the user is impossible.

On the other hand, reconstruction of the man-machine interface by a user himself/herself or new creation of the same can be considered. However, in the conventional history data management system, it is difficult to cope with the man-machine interface reconstructed or created by the user himself/herself. Therefore, it is hard to output and manage the retrieval result data desired by the user in a state where the retrieval result data can be utilized as it is by the user.

It is to be noted that the above-describe problems are problems which generally exist in the history data management system which stores the plant data as the history data as well as a history data management system which stores various kinds of history data, e.g., sales performance data of various commodities such as products or services or purchase performance data of customers, and outputs retrieval result data in a predetermined file format style in response to a retrieval request from a plurality of user terminals.

### BRIEF SUMMARY OF THE INVENTION

It is an object of the present invention to provide a history data management system which can issue a retrieval request reflecting an intention of a user through a retrieval interface previously provided in a user terminal or a man-machine interface created by the user, and can output retrieval result data obtained by performing retrieval in response to the retrieval request in a state where it can be utilized by the user as it is without effecting any special operation.

It is a more concrete object of the present invention to provide a history data management system which can save retrieval result data output in response to a retrieval request from a user terminal in a format style which can be utilized by a user as it is at a save position which can be used as it is under a file name which can be utilized as it is without requiring an operation such as a change in the format, a change in the save position, a change in the file name or the like.

Further, it is another concrete object of the present invention to provide a history data management system which automatically executes periodic retrieval and can output retrieval result data in a state where it can be used by a user as it is without requiring sequential issue of a retrieval request in case a case where the user periodically acquires the retrieval result data.

It is still another concrete object of the present invention to provide a history data management system which can readily issue a retrieval request assuredly reflecting an intension of a user through a man-machine interface created by the user which has been subjected to free specification changes or created on the user side, and can provide retrieval result data obtained in response to the retrieval request in the most user-friendly state.

To this end, according to the present invention, retrieval result data obtained on a data server side in response to a retrieval request from a user terminal is output to an output destination different from that of original history data, and output conditions or the like for the retrieval result data intended by a user are reflected in the retrieval request. As a result, the retrieval result data desired by the user can be utilized by the user as it is through a retrieval interface previously provided in the user terminal or a man-machine interface created by the user.

It is to be noted that important terms in the present invention area defined as follows.

The history data is not restricted to history data such as plant data which can be a retrieval target, and it is an extensive concept including retrieval result data obtained by retrieving the history data as a retrieval target.

“Retrieval request” is a generic term of information transmitted in order to perform retrieval of history data, and it is a concept including information which can be various kinds of conditions concerning retrieval. Moreover, it is not restricted to a real-time retrieval request, and it is an extensive concept including a retrieval request or the like which is used to book future or periodic retrieval execution.

“Response notification” is a generic term of a notification transmitted to a user terminal which has issued a retrieval request in response to the retrieval request after receiving the retrieval request from the user terminal. That is, it is not restricted to a notification including information concerning a retrieval result obtained by retrieving history data, and it is an extensive concept including a notification which includes any information relating to the retrieval request.

“Retrieval result data” means substantive data obtained by retrieval of history data with respect to a retrieval request, and it is data corresponding to an object of a retrieval request.

“Retrieval result” is a generic term of information indicative of a result of retrieval which has been performed with respect to a retrieval request, and it is an extensive concept which includes not only substantive retrieval result data but also information concerning any state acquired as a result of retrieval such as success and failure of retrieval.

“Retrieval execution conditions” is a term which means various kinds of conditions required to execute retrieval of history data, and it is a concept including a retrieval target period, a data class and others.

“Output conditions of retrieval result data” is a term which means conditions under which retrieval result data is output, and it is a concept including an output format, an output destination, an output file and others.

“Man-machine interface created by a user” means a man-machine interface entirely or partially created by a user himself/herself. In this case, this term includes an example where a user has appropriately changed specifications of the man-machine interface previously created as a part of a system. Additionally, it is not restricted to one created in a user terminal, and it is an extensive concept including one created by a computer outside the system and mounted in the user terminal.

The system based on the viewpoint of the present invention is configured to include retrieval interface means and data retrieving means in a history data management system which comprises: a user terminal utilized by each user; and a data server which stores history data, receives a retrieval request from the user terminal through a communication network, perform retrieval of the history data in response to the received retrieval request and returns a response notification for the retrieval request to the user terminal which has issued the retrieval request.

The retrieval interface means is means which creates in a user terminal a retrieval request including information as retrieval execution conditions under which retrieval is executed based on information supplied from a user, transmits the created retrieval request to the data server through the communication network and receives a response notification for the retrieval request. Furthermore, the data retrieving means is means which retrieves in the data server history data based on the information as the retrieval execution conditions included in the retrieval request from the user terminal, outputs retrieval result data acquired as a result of retrieval to an output destination other than a position where the history data is stored, and returns a response notification for the retrieval request to the user terminal which has issued the request.

Moreover, the retrieval interface means is configured to create as the retrieval request a retrieval request which is classified into at least one of a retrieval request including information as output conditions for retrieval result data and a retrieval result based on information supplied from a user through man-machine interface means created by the user.

According to the above-described system of the present invention, retrieval result data acquired on the data server side in response to a retrieval request from the user terminal is output to an output destination separately from original history data, and output conditions or the like of the retrieval result data intended by the user are reflected in the retrieval request. As a result, the retrieval result data desired by the user can be utilized as it is by the user through the retrieval interface previously provided in the user terminal or the man-machine interface created by the user. Therefore, a retrieval request reflecting the intension of the user can be issued through the retrieval interface previously provided in the user terminal or the man-machine interface created by the user. Additionally, the retrieval result data acquired by executing retrieval in response to the retrieval request can be output in a state where it can be utilized as it is by the user without requiring any special operation.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a configuration of a system concerning a first embodiment according to the present invention;

FIG. 2 is a view showing a record configuration of plant data saved in a plant database depicted in FIG. 1;

FIG. 3 is a view showing a record configuration of number information saved in a point number information database depicted in FIG. 1;

FIG. 4 is a flowchart showing a processing procedure of the system depicted in FIG. 1;

FIG. 5 is a view showing a configuration of a retrieval request created in a user terminal depicted in FIG. 1;

FIG. 6 is a view showing a concrete configuration of an output format style in a retrieval request depicted in FIG. 5;

FIG. 7 is an explanatory view showing an example where a value of each information is concretely specified with respect to the output format style depicted in FIG. 6;

FIG. 8 is a view showing an example of retrieval result data output in a file format style based on an output format depicted in FIG. 7;

FIG. 9 is a block diagram showing a configuration of a system according to a second embodiment of the present invention;

FIG. 10 is a flowchart showing a processing procedure of the system depicted in FIG. 9;

FIG. 11 is a view showing a configuration of a retrieval request created in a user terminal depicted in FIG. 9;

FIG. 12 is a block diagram showing a configuration of a system according to a third embodiment of the present invention;

FIG. 13 is a flowchart showing a processing procedure of the system depicted in FIG. 12;

FIG. 14 is a view showing a configuration of a retrieval request created in a user terminal depicted in FIG. 12;

FIG. 15 is a block diagram showing a configuration of a system according to a fourth embodiment of the present invention;

FIG. 16 is a flowchart showing a processing procedure of a system depicted in FIG. 15;

FIG. 17 is a view showing configurations of a retrieval request based on a user specification processed in a user terminal depicted in FIG. 15 and a retrieval request based on a system specification;

FIG. 18 is a block diagram showing a configuration of a system concerning a fifth embodiment according to the present invention;

FIG. 19 is a flowchart showing a processing procedure of the system depicted in FIG. 18;

FIG. 20 is a view showing configurations of a retrieval request based on a user specification processed in a user terminal depicted in FIG. 18 and a retrieval request based on a system specification;

FIG. 21 is a block diagram showing a configuration of a system according to a sixth embodiment of the present invention;

FIG. 22 is a flowchart showing a processing procedure of the system depicted in FIG. 21;

FIG. 23 is a view showing configurations of a retrieval request based on a user specification processed in a user terminal depicted in FIG. 21 and a retrieval request based on a system specification;

FIG. 24 is a block diagram showing a configuration of a system according to a seventh embodiment of the present invention;

FIG. 25 is a flowchart showing a processing procedure of a system depicted in FIG. 24; and

FIG. 26 is a view showing configurations of a retrieval request based on a user specification processed in a user terminal depicted in FIG. 24 and a retrieval request based on a system specification.

### DETAILED DESCRIPTION OF THE INVENTION

Each embodiment according to the present invention will now be described hereinafter with reference to the accompanying drawings.

The present invention is generally applicable to various kinds of history data management systems which store various kinds of history data and output result data in a predetermined file format style in response to a retrieval request from a plurality of user terminals and, in particular, preferable to a history data management system which manages plant data as history data.

[First Embodiment]

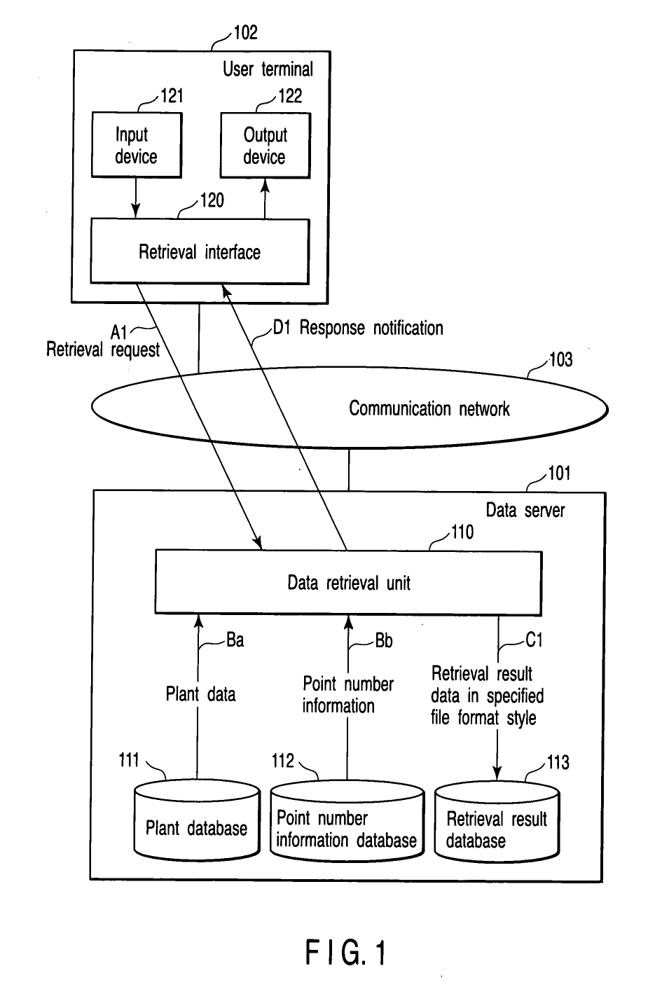

(System Configuration) FIG. 1 is a block diagram showing a configuration of a history data management system according to a first embodiment.

As shown in FIG. 1, this system is configured by connecting a data server 101 which stores plant data concerning operating states of a plant for a long period with a user terminal 102 utilized by a user in business including plant data retrieval through a communication network 103 such as the Internet or an intranet. The data server 101 and the user terminal 102 will be sequentially described hereinafter in detail.

First, the data server 101 includes a data retrieval unit 110 which performs data retrieval based on a retrieval request A1 from the user terminal 102. Furthermore, the data server 101 includes as databases a plant database 111 in which plant data Ba is saved, a point number information database 112 in which point number information Bb is saved, and a retrieval result database 113 in which retrieval result data C1 is saved.

The data retrieval unit 110 performs retrieval in the plant database 111 and the point number information database 112 based on the retrieval request A1 including specification of a file format style at the time of output from the user terminal 102, converts obtained retrieval result data into retrieval result data C1 in the file format specified by the retrieval request A1, and saves it in the retrieval result database 113. Furthermore, the data retrieval unit 110 returns a response notification D1 including a retrieval result state to the user terminal 102 which has issued the request.

It is to be noted that the data retrieval unit 110 is realized by a combination of hardware such as a processor, a main memory, an auxiliary storage device and the like which are usually provided in a computer and software specialized for this system such as a program or data for the data server stored in the main memory and the auxiliary storage device.

The plant data Ba saved in the plant database 111 is dynamic data such as data periodically transmitted from a supervisory control computer or any other data collection device in a plant or data concerning operating states in a plant manually input from a business terminal by a person in charge of affairs.

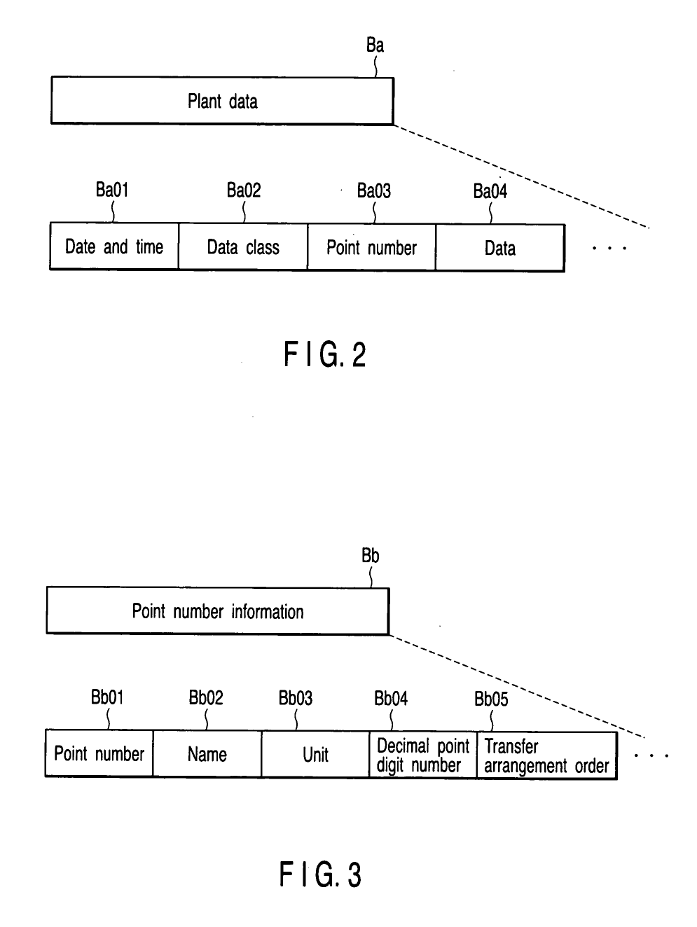

FIG. 2 is a view showing a record configuration of such plant data Ba, and each plant data Ba includes information such as a date and time Ba01, a data class Ba02, a point number Ba03, data Ba04 or the like and expresses a value of each date and time of each variable in each section in the plant.

Here, the date and time Ba01 is information which specifies a date and time at which each data is acquired, e.g., a date and time at which data is created or received. The data class Ba02 is information is information which specifies a class of each variable in each section in the plant expressed by each data. Further, the point number Ba03 is a number which specifies each variable in each section in the plant expressed by each data. The data Ba04 is information indicative of a value of each variable in each section expressed by a point number, and it is a main part of each plant data Ba.

Furthermore, the point number information Bb saved in the point number information database 112 is fixed information concerning point information. FIG. 3 is a view showing a record configuration of such point number information Bb. Each point number information Bb includes, as shown in FIG. 3, information such as a point number Bb01, a name Bb02, a unit Bb03, a decimal point digit number Bb04, a transfer arrangement order Bb05 and others.

It is to be noted that the plant database 111 and the point number information database 112 are configured in predetermined fixed save destinations in the data server 101. Moreover, in this embodiment, the retrieval result database 113 is also configured in a predetermined fixed save destination in the data server 101 separately from these databases 111 and 112.

On the other hand, the user terminal 102 is provided with a retrieval interface 120 which creates a retrieval request A1 including specification of a file format style at the time of output, transmits this retrieval request to the data server 101 and receives a response notification D1 from the data server 101. Additionally, the user terminal 102 is provided with an input device 121 such as a keyboard or a mouse and an output device 122 such as a display by which data is input/output to/from a user.

Here, the retrieval interface 120 creates the retrieval request A1 including specification of a retrieval target period, specification of a data class and others as information which can be retrieval execution conditions and also including specification of a file format style at the time of output as information which can be retrieval result output conditions, and transmits the retrieval request A1 to the data server 101.

The retrieval interface 120 is realized by a combination of hardware such as a processor, a main memory, an auxiliary storage device and others which are usually included in the computer and software specialized for this system such as a program or data for the user terminal stored in the main memory and the auxiliary storage device.

It is to be noted that the drawing shows the single user terminal 102 alone for simplification and clarification, but the plurality of user terminals 102 are actually connected. Further, although the drawing shows characteristic structures or function portions according to this embodiment only about the data server 101 and the user terminal 101 for simplification and clarification, there are actually provided a variety of means, function portions, peripheral devices and others.

(Processing Procedure)

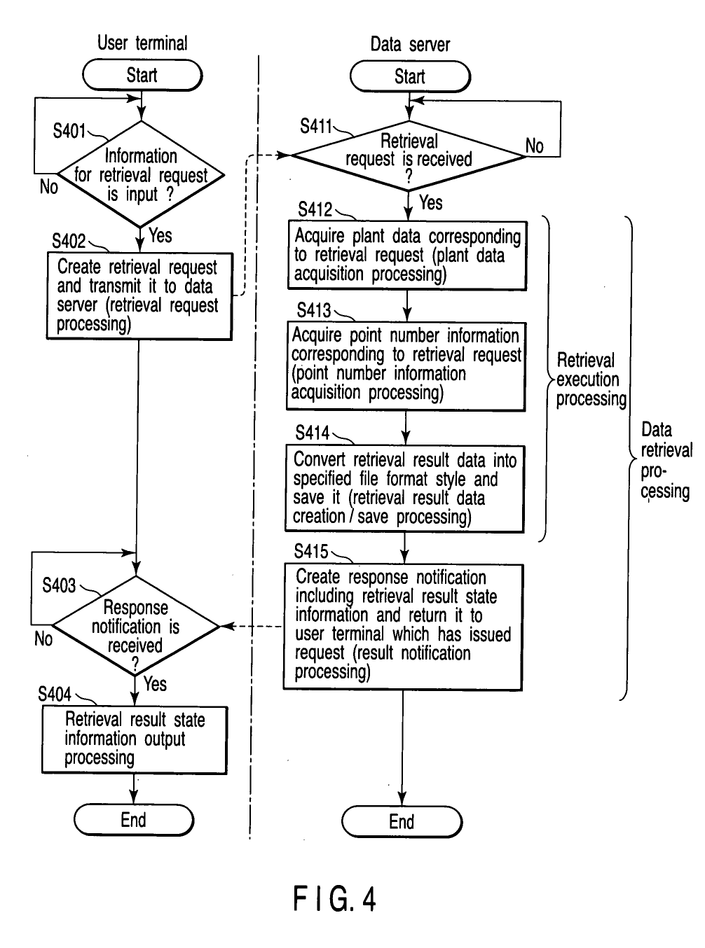

FIG. 4 is a flowchart showing a processing procedure of the system depicted in FIG. 1.

As shown in FIG. 4, when information required to issue the retrieval request A1 is given by the input device 121 in the user terminal 102 from a user (YES at S401), the retrieval interface 120 creates the retrieval request A1 including specification of a file format style at the time of output based on the given information. Furthermore, the retrieval interface 120 transmits the retrieval request A1 to the data server 101 through the communication network 103 (S401).

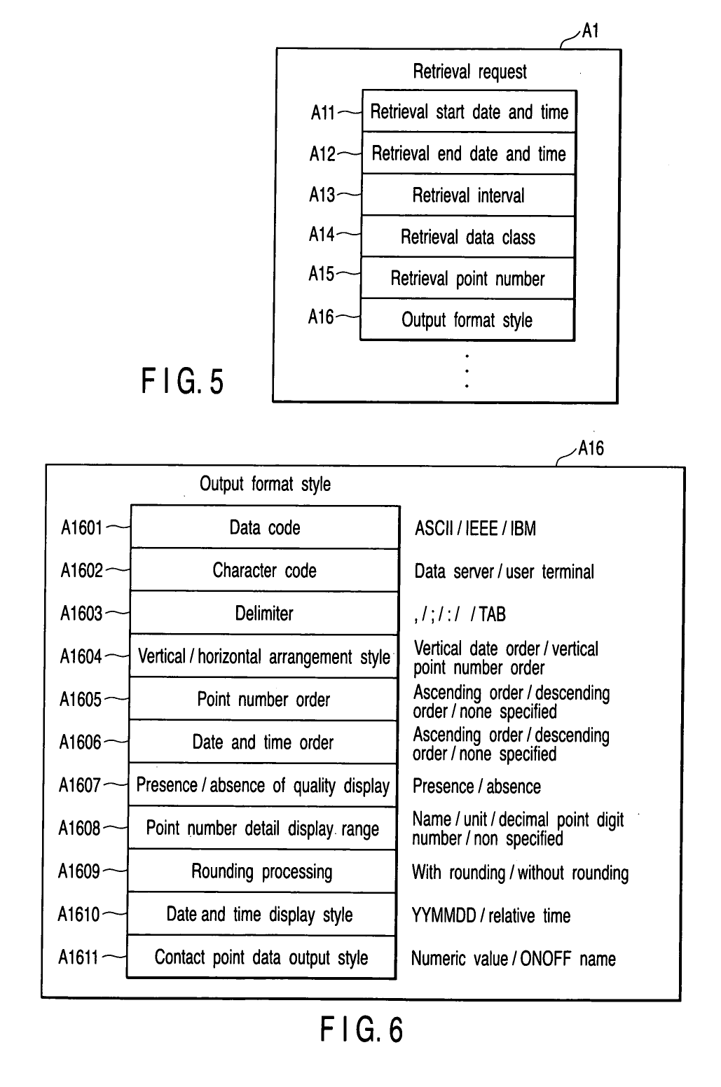

FIG. 5 is a view showing a configuration of such a retrieval request A1. The retrieval request A1 includes specification of a retrieval start date and time A11, a retrieval end date and time A12, a retrieval interval A13, a retrieval data class A14, a retrieval point number A15 and others as information which can be retrieval execution conditions. Moreover, the retrieval request A1 includes specification of an output format style A16 and others as information which can be retrieval result output conditions.

Here, the retrieval start date and time A11 and the retrieval end date and time A12 are dates and times at which a retrieval target period starts and ends. The retrieval interval A13 is a time interval between data acquired in the retrieval target period. Additionally, the output format style A16 is a file format style at the time of output.

The retrieval interface 120 performs input assistance, e.g., presenting a selection window to a user in accordance with each information constituting such a retrieval request A1. As a result, a user can readily specify information required for the retrieval request.

When the retrieval request A1 transmitted from the user terminal 102 is received through the data retrieving means 110 in the data server 101 (YES at S411), the data retrieval unit 110 executes a series of retrieval execution processing, i.e., plant data acquisition processing (S412), point number information acquisition processing (S413) and retrieval result data creation/save processing (S414), and then performs result notification processing (S415). The detail of each processing (S412 to S415) is as follows.

The plant data acquisition processing (S412) is processing which acquires the plant data Ba corresponding to the retrieval request A1 from the plant database 111. Specifically, the plant data Ba having the data class Ba02 and the point number Ba03 matching with the specified retrieval data class A14 and retrieval point number A15 is repeatedly acquired in accordance with the specified retrieval interval A13 until the specified retrieval end date and time A12 in an ascending order of the date and time Ba01 with the retrieval start date and time A11 specified in the retrieval request A1 as a start point, and the data BaO4 included in each plant data Ba is taken out.

The point number information acquisition processing (S413) is processing which acquires the point number information Bb corresponding to the retrieval request A1 from the point number information database 112. Specifically, the point number information Bb having a point number 301 matching with the retrieval point number A15 specified in the retrieval request A1 is acquired, and the name Bb02, the unit Bb03, the decimal point digit number Bb04 and others included in each point number information Bb are taken out.

In the retrieval result data creation/save processing (S414), the retrieval result data obtained by the plant data acquisition processing and the point number information acquisition processing is converted into retrieval result data C1 in a specified file format style in accordance with the output format style A16 in the retrieval request A1, and saved in the retrieval result database 113 configured at a predetermined fixed save destination in the data server 101.

The result notification processing (S415) creates a response notification D1 including retrieval result state information, e.g., whether a retrieval result state obtained as a result of each preceding processing (S412 to S415), i.e., all data corresponding to the retrieval request has been acquired or whether the obtained retrieval result data has been normally saved in the specified file format style in the retrieval result database 113 as a response notification, and returns the created response notification D1 to the user terminal 102 which has issued the request.

When the response notification D1 transmitted from the data server 101 is received through the retrieval interface 120 in the user terminal 102 which has issued the request (YES at S403), the retrieval interface 120 outputs retrieval result state information included in the response notification D1 from the output device 122 as retrieval result state information output processing (S404).

It is to be noted that the series of processing (S401 to S404 and S411 to S415) of the above-described user terminal 102 and data server 101 is repeatedly executed while the user terminal 102 is connected with the data server 101.

(Examples of Output Format Style and Retrieval Result Data)

FIG. 6 is a view showing a concrete configuration of the output format style A16 in the retrieval request A1 depicted in FIG. 5.

As shown in FIG. 6, the output format style A16 includes information such as a data code A1601, a character code A1602, a delimiter A1603, a vertical/horizontal arrangement style A1604, a point number order A1605, a date and time order A1606, presence/absence of quality display A1607, a point number detail display range A1608, rounding processing A1609, a date and time display style A1610, a contact point data output style A1611 and others. Values of the respective information A1601 to A1611 which can be specified will be sequentially explained below.

As to the data code A1601, a data code such as “ASCII/IEEE/IBM” can be specified. In regard to the character code A1602, a character code such as “data server/user terminal” can be specified. About the delimiter A1603, a delimiter such as “, (comma)/; (semicolon)/ (blank)/TAB” can be specified.

Additionally, as to the vertical/horizontal arrangement style A1604, an item which can be a reference of a vertical arrangement order such as “vertical date order/vertical point number order” can be specified. In regard to the point number order A1605, a point number arrangement order such as “ascending order/descending order/non specified” can be specified. About the date and time order A1606, a date and time arrangement order such as “ascending order/descending order/non specified” can be specified.

As to the presence/absence of quality display A1607, “presence/absence” can be specified. In regard to the point number detail display range A1608, a display range such as “name/unit/decimal point digit number/non specified” can be specified. About the rounding processing A1609, “with rounding/without rounding” can be specified. As to the date and time display style A1610, a time display style such as “YYMMDD/relative time” can be specified. In regard to the contact point data output style A1611, a contact point data output style such as “numeric value/ONOFF name” can be specified.

It is to be noted that, as concrete processing which specifies each information A1601 to A1611 in such an output format style A16, for example, a leftmost value of each information A1601 to A1611 in the drawing is set as a default value and presented to a user. When the user does not specify a different value, it is possible to execute processing which determines the value of each information A1601 to A1611 as specification information in the output format style.

Further, it is also possible to perform processing which automatically resets the previous output format style as a new default value and presents it to a user. Alternatively, it is possible to execute processing which allows a user himself/herself to freely set a default value of each information in the output format style and the allows manual selection only when a different output format style is specified.

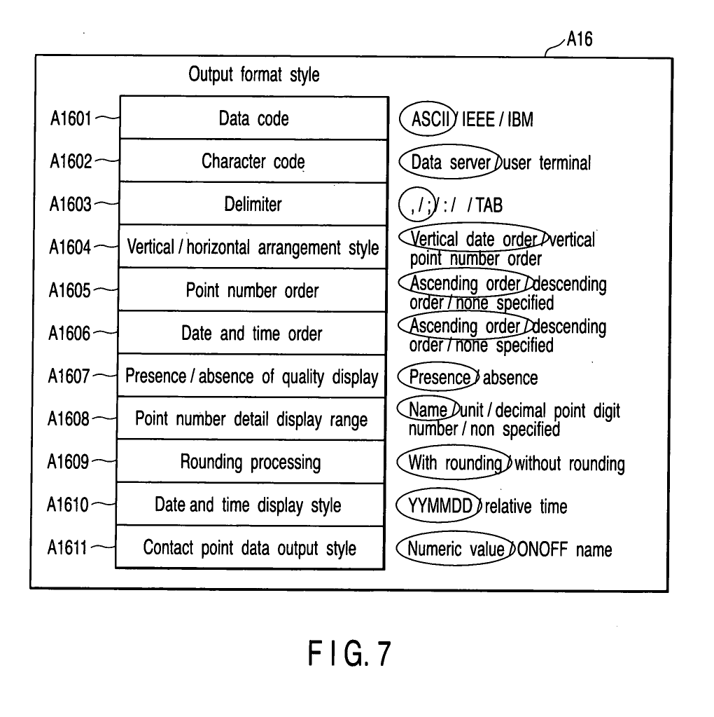

FIG. 7 is an explanatory view showing an example where a value of each information is concretely specified about the output format style A16 depicted in FIG. 6.

As shown in FIG. 7, “ASCII” is specified in the data code A1601. “Data server” is specified in the character code A1602. “, (comma)” is specified in the delimiter A1603.

Further, “vertical date order” is specified in the vertical/horizontal arrangement style A1604. “Ascending order” is specified in the point number order A1605. “Ascending order” is specified in the date and time order A1606. “Absence” is specified in the presence/absence of quality display A1607. “Name” is specified in the point number detail display range A1608. “With rounding” is specified in the rounding processing A1609.

Furthermore, “YYMMDD” is specified in the date and time display style A1610. “Numeric value” is specified in the contact point data output style A1611.

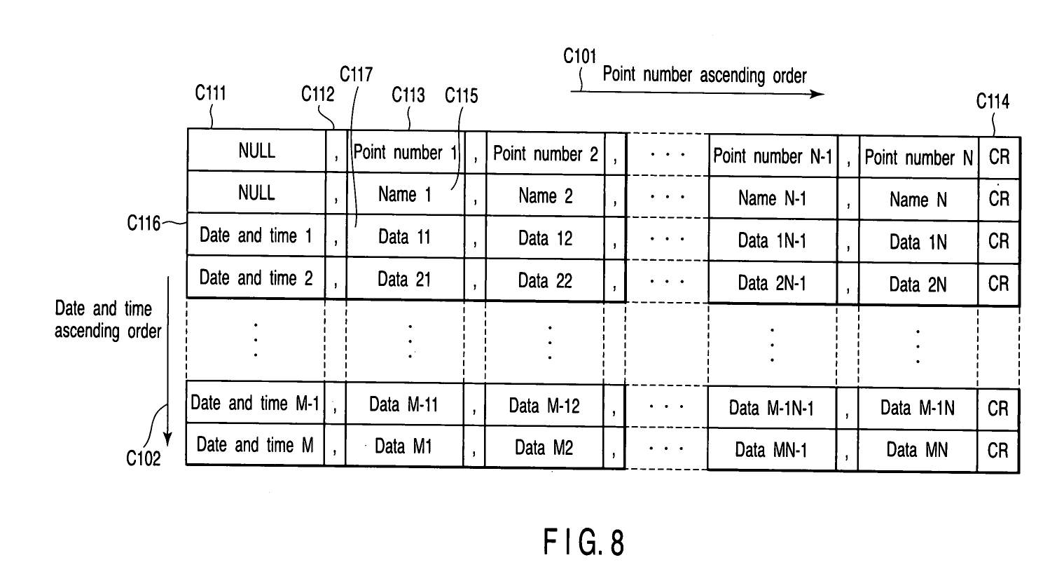

FIG. 8 is a view showing an example of the retrieval result data C1 output in a file format style based on the specified output format style A16 depicted in FIG. 7.

As shown in FIG. 8, the retrieval result data C1 is constituted with a point number ascending order C101 in a horizontal direction (a column direction) and a vertical and horizontal arrangement of a date and time ascending order C102 in a vertical direction (a row direction) based on specification of the output format style A16 depicted in FIG. 7. Here, a header row is output in a first row. A point number detail display row is output in a second row. Moreover, data rows are output from a third row.

Here, as to a configuration of the header row (the first row), a NULL character C111 is output firstly, a delimiter character C112 “, (comma)” is output secondly, and respective point numbers C113 from a point number 1 to a point number N are output with the delimiter C112 “, (comma)” therebetween thirdly and later. At last, a line feed code C114 is output.

A configuration of the point number detail display row (the second row) corresponds to the header row, the NULL character C111 is output firstly, the delimiter C112 “, (comma)” is output secondly, and respective names C115 from the point number 1 to the point number N are output with the delimiter C112 “, (comma)” therebetween thirdly and later. At last, the line feed code C114 is output.

In regard to a configuration of the data row (the third or subsequent rows), a date and time C116 is firstly output in a YYMMDD style. The delimiter C112 “, (comma)” is output secondly. Data C117 corresponding to N point numbers, i.e., the point number 1 to the point number N is output with the delimiter C112 “, (comma)” therebetween thirdly or later. At last, the line feed code C114 is output. The data rows corresponding to the number of retrieval target rows M are output from a date and time 1.

(Effects of First Embodiment)

According to the FIG. 1 system described above, the following effects can be obtained.

That is, a user can specifies a file format style at the time of outputting retrieval result data in the user terminal. Transmitting the retrieval request including this specified file format style can execute retrieval corresponding to the retrieval request on the data server side. This retrieval result data is saved in a predetermined retrieval result database in the file format style specified by the user.

Therefore, the retrieval result data obtained by retrieval can be automatically saved at a predetermined position in the data server in a user-friendly style by just specifying a preferable file format style that the user can easily use. Therefore, the user can easily perform secondary data utilization of the retrieval result data without performing an operation of changing a style of the retrieval result data.

[Second Embodiment]

(System Configuration)

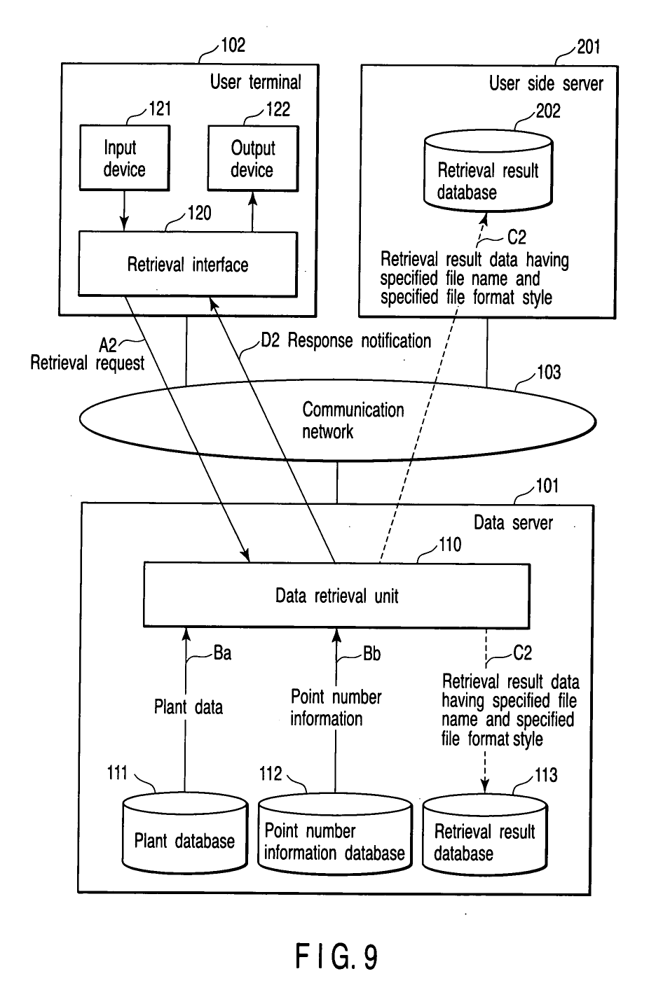

FIG. 9 is a block diagram showing a configuration of a history data management system concerning a second embodiment.

The system shown in FIG. 9 corresponds to a modification of the system depicted in FIG. 1, additionally has functions of the data server 101 and the user terminal 102 in the FIG. 1 system and additionally includes a user side server 201 connected with the communication network 103.

Here, the user side server 201 is a server which manages data used for a business including plant data retrieval or another business by a user. The user side server 201 is a server dedicated to a single user or a shared server utilized by a plurality of users.

A retrieval result database 202 which saves retrieval result data C2 is provided in the user side server 201. It is to be noted that the drawing shows the single user side server 201 alone for simplification and clarification, but the plurality of user side servers 201 which can be utilized by the user terminal 102 are connected with the single user terminal 102 in many cases. Likewise, respective retrieval result databases 202 are provided in the plurality of user side server 201.

In this system, a user can specifies a save destination for the retrieval result data C2 from the data server 101 and the plurality of user side servers 201. Moreover, the user can freely specify a save file name of the retrieval result data C2.

That is, in this system, a retrieval interface 120 in the user terminal 102 is configured to create a retrieval request A2 which includes specification of a retrieval target period, specification of a data class and others as information which can be retrieval execution conditions and also includes specification of a file format style at the time of output as well as specification of a save destination and specification of a save file name as information which can be retrieval result output conditions, and transmit the created request to the data server 101.

A data retrieval unit 110 in the data server 101 does not fixedly save retrieval result data obtained based on such a retrieval request A2 including specification of a file format style, specification of a save destination and specification of a save file in the data server 101, but converts the obtained retrieval result data into retrieval result data C2 having a specified file name and a specified file format style and saves it at a save destination specified from a user. FIG. 9 indicates the retrieval result data C2 by an arrow of a broken line in order to express that an output destination of the retrieval result data C2 varies in accordance with specification of a save destination.

(Processing Procedure)

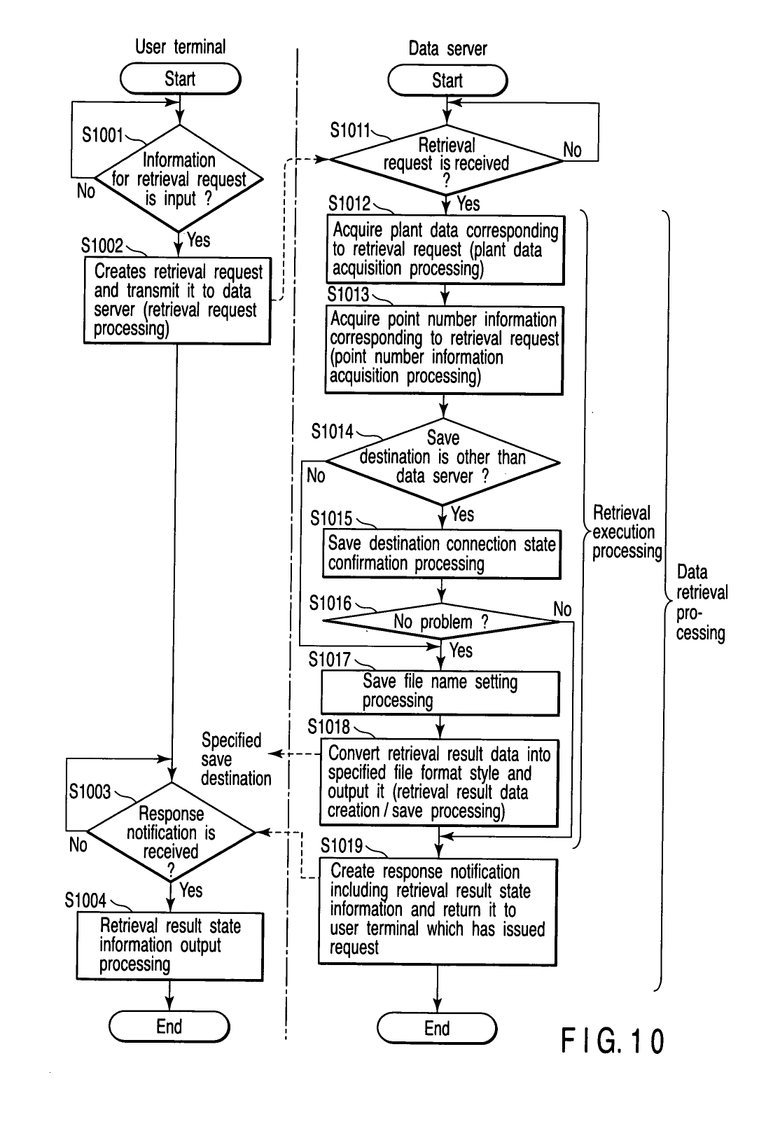

FIG. 10 is a flowchart showing a processing procedure of the system depicted in FIG. 9.

As shown in FIG. 10, when information required to issue the retrieval request A2 is given by an input device 121 in the user terminal 102 from a user (YES at S1001), the retrieval interface 120 creates the retrieval request A2 including specification of a file format style as well as specification of a save destination and specification of a save file name based on this information. Further, the retrieval interface 120 transmits the retrieval request A2 to the data server 101 through the communication network 103 (S1002).

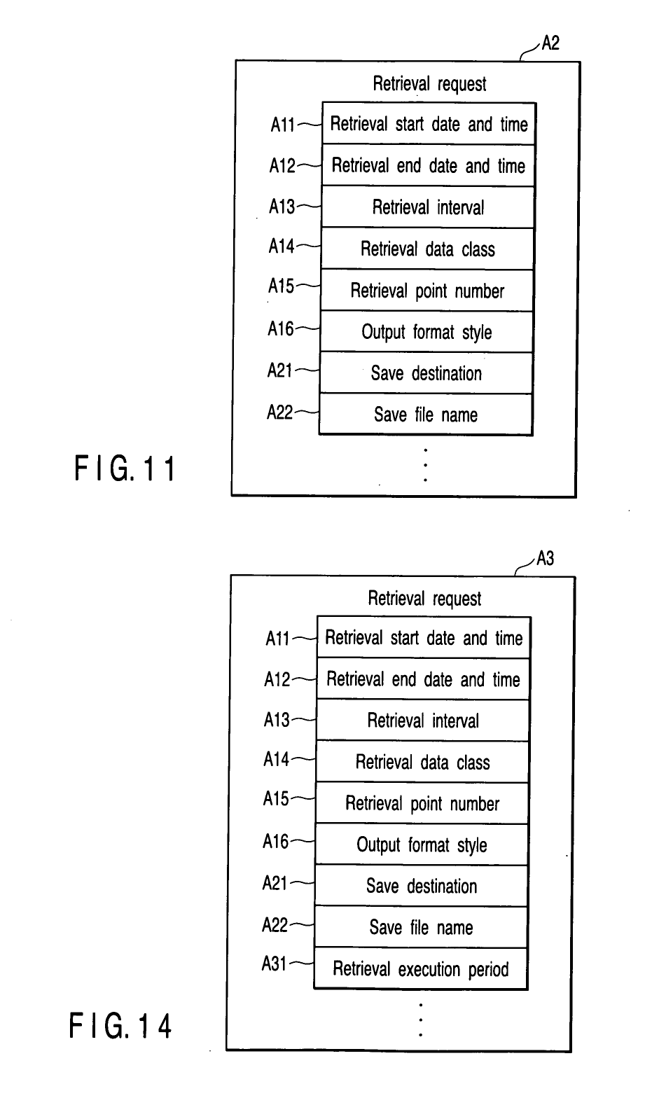

FIG. 11 is a view showing a configuration of such a retrieval request A2. The retrieval request A2 includes specification of a retrieval start date and time A11, a retrieval end date and time A12, a retrieval interval A13, a retrieval data class A14, a retrieval point number A15 and others as information which can be retrieval execution conditions, and also includes specification of an output format style A16 as well as a save destination A21 and a save file name A22 as information which can be retrieval result output conditions.

In this case, as an input assistance method which allows a user to specify the save destination A21 or the save file name A22, for example, presenting a selection window to the user can be considered as described above. Additionally, as more concrete processing to specify the save destination A21, for example, the data server 101 is set as a default value and presented to the user, and data is automatically saved in the data server 101 when a different save destination is not specified from the user. Further, only when a different save destination is specified, it is possible to execute processing of saving data in the specified save destination, for example.

Furthermore, it is also possible to carry out, e.g., processing of automatically resetting the previous save destination as a new default value and presenting it to a user. Alternatively, it is possible to execute processing of, e.g., allowing a user himself/herself to freely set a default value of a save destination, previously setting the user side server 201 which is most frequently utilized as a save destination and allowing manual selection only when data is stored in a different save destination.

Moreover, as more concrete processing for specifying the save file name A22, for example, a file name such as a serial number based on a predetermined rule is automatically added as a default value to the retrieval result data C2 with respect to the retrieval request from the same user terminal. On the other hand, when there is no specification of a different file name from a user, it is possible to execute processing of determining this file name as specification information of a save file name. Additionally, it is also possible to carry out processing of, e.g., automatically resetting the previous save file name as a new default value and presenting it to a user. Alternatively, it is possible to perform processing of, e.g., allowing a user himself/herself to freely set a rule or the like which is used to add a save file name, and allowing manual specification of a file name only when a special file name is added.

In the data server 101, a processing procedure to receive the retrieval request A2 transmitted from the user terminal 102 by a data retrieval unit 110 (YES at S1011) and execute plant data acquisition processing (S1012) and point number information acquisition processing (S1013) is the same as the processing procedure depicted in the flowchart of FIG. 4.

In the system shown in FIG. 9, when the save destination A21 specified in the retrieval request A2 is other than the data server 101 (YES at S1014), the data retrieval unit 110 confirms whether the actual save destination, i.e., the user side server 201 is normally connected with the communication network 103 as save destination connection state confirmation processing after the above-described processing (S1015). If the save destination is normally connected (YES at S1016), the data retrieval unit 110 determines the save file name A22 included in the retrieval request A2 as a file name of the retrieval result data C2 which is stored in the save destination (S1017) as save file name setting processing. Subsequently, the data retrieval unit 110 converts retrieval result data acquired by the plant data acquisition processing and the point number information acquisition processing into retrieval result data C2 in a file format style specified based on an output format style A16 in the retrieval request A2 as retrieval result data creation/save processing. Additionally, the data retrieval unit 110 transmits the retrieval result data C2 to the user side server 201 which is the normally connected save destination, and saves it in the retrieval result database 202 in the user side server 201 (S1018).

When the retrieval result data C2 is saved with the specified file name and the specified file format style in the save destination specified in the retrieval request A2 in this manner, the data retrieval unit 110 creates a response notification D2 including retrieval result state information indicating that the data has been normally saved as result notification processing, and returns it to the user terminal 102 which has issued the request (S1019).

Further, when the actual save destination specified based on specification of the save destination A21 is not normally connected (NO at S1016), the data retrieval unit 110 creates a response notification D2 including retrieval result state information indicative of a connection defect of the save destination as result notification processing, and returns the created notification to the user terminal 102 which has issued the request (S1019) as result notification processing.

On the other hand, when the save destination is the data server 101 (NO at S1014), the data retrieval unit 110 executes the save file name setting processing (S1017), the retrieval result data creation/save processing (S1018) and the result notification processing (S1019) alone.

Furthermore, in the user terminal 102 which has issued the request, when the retrieval interface 120 receives the response notification D2 transmitted from the data server 101 (YES at S1003), the retrieval interface 120 executes retrieval result state information output processing like the processing procedure depicted in FIG. 4 (S1004).

(Effects of Second Embodiment)

According to the system of this embodiment shown in FIG. 9, in addition to the same effects as those of the system depicted in FIG. 1, the following effects can be further obtained.

That is, in the user terminal, a user can specify not only a file format style at the time of outputting retrieval result data but also a save destination or a save file name. Moreover, a retrieval request including these specified retrieval result output conditions can be transmitted to the data server. As a result, retrieval corresponding to the retrieval request is executed on the data server side, and the retrieval result data is saved with a file name specified by the user and a file format style specified by the user in a save destination specified by the user.

Therefore, the retrieval result data obtained by retrieval is automatically saved with an easy-to-use file name with a user-friendly style in a save destination which can be readily utilized by a user when the user just specifies a preferable file format style which can be readily utilized by the user as well as a preferable save destination or file name which can be easily used by the user. Therefore, the user does not have to again perform a style change operation, a save position change operation, a file name change operation and others, and can assuredly and easily unify the management of the retrieval result data.

(Modification)

It is to be noted that the description has been given as to the example where a destination to save the retrieval result data is selected from the data server 101 and the plurality of user side servers 201 in the system depicted in FIG. 9, but the following modification can be employed.

That is, a save destination may be selected from not only the data sever 101 and the plurality of user side servers 201 but also the user terminal 102 which has issued the request or many save destinations including a different terminal, a different server or the like connected with the communication network 103.

Further, although the description has been given as to the example where a save destination and a save file name of the retrieval result data are specified in the system depicted in FIG. 9, it is possible to specify a save destination alone without specifying a save file name, or specify a save file name alone without specifying a save destination as a modification.

When a save file name is not specified, there is carried out processing of automatically giving a file name based on a predetermined file name setting rule, e.g., a serial number. Furthermore, when a save destination is not specified, there is executed processing of automatically saving the retrieval result data in a predetermined save destination in the data server or the like.

[Third Embodiment]

(System Configuration)

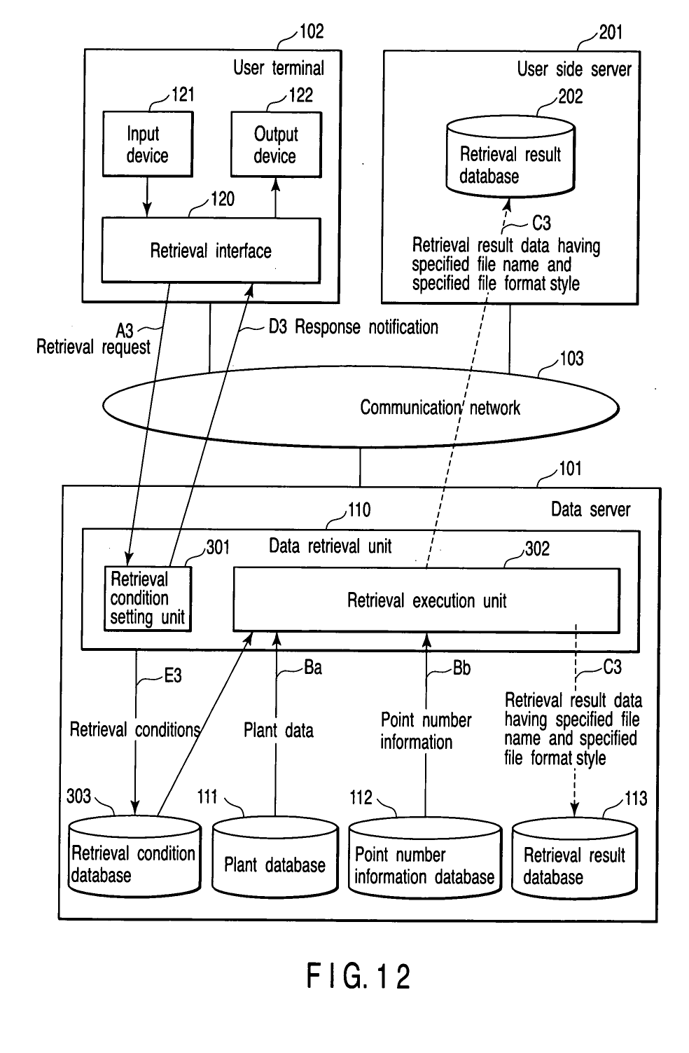

FIG. 12 is a block diagram showing a configuration of a history data management system concerning a third embodiment.

The system depicted in FIG. 12 corresponds to a modification of the FIG. 9 system, additionally has a configuration and a function of the data server 101 in the FIG. 9 system and additionally has a function of the user terminal 102.

In this system, a user can freely specify a retrieval execution period in which retrieval is executed. The data server 101 periodically performs data retrieval processing based on specification of such a retrieval execution period. That is, in this system, a retrieval interface 120 of a user terminal 102 creates a retrieval request A3 including specification of a file format style at the time of output, specification of a save destination and specification of a save file name as information which can be retrieval result output conditions, specification of a retrieval target period, specification of a data class and others as information which can be retrieval execution conditions as well as specification of a retrieval execution period in which retrieval is executed, and transmits the created request to the data server 101.

A data retrieval unit 110 in the data server 101 is provided with a retrieval condition setting unit 301 which sets retrieval conditions E3 including the above-described information based on such a retrieval request A3 including specification of a file format style, specification of a save destination, specification of a save file name and specification of a retrieval execution period. Moreover, the data retrieval unit 110 includes a retrieval execution unit 302 which executes retrieval based on the retrieval conditions E3. Here, the retrieval conditions E3 set in the retrieval condition setting unit 301 are saved in a retrieval condition database 303 provided in the data server 101.

The retrieval execution unit 302 of the data retrieval unit 110 periodically repeats data retrieval processing based on the retrieval conditions E3 saved in the retrieval condition database 303, converts obtained retrieval result data into retrieval result data C3 having a specified file name and a specified file format style, and saves it in a save destination specified by a user.

In FIG. 12, the retrieval result data C3 is indicated by an arrow of a broken line like FIG. 9 in order to express that an output destination of the retrieval result data C3 varies depending on specification of a save destination.

(Processing Procedure)

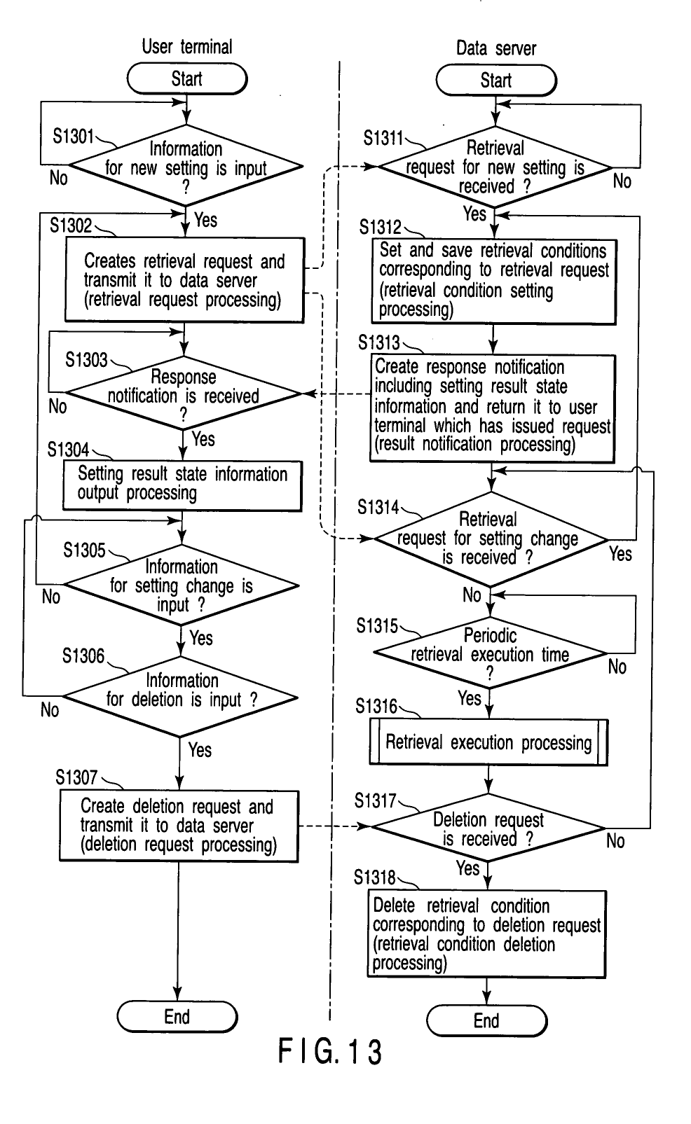

FIG. 13 is a flowchart showing a processing procedure of the system depicted in FIG. 12.

As shown in FIG. 13, when information required to issue a retrieval request A3 for new setting is given by an input device 121 in the user terminal 102 from a user (YES at S1301), the retrieval interface 120 creates a new retrieval request A3 including specification of a file format style, specification of a save destination and specification of a save file name as well as specification of a retrieval execution period based on this information, and transmits the created request to the data server 101 through a communication network 103 (S1302).

FIG. 14 is a view showing a configuration of such a retrieval request A3 for new setting.

The retrieval request A3 includes specification of a retrieval start date and time A11, a retrieval end date and time A12, a retrieval interval A13, a retrieval data class A14, a retrieval point number A15 and others as well as specification of a retrieval execution period A31 as information which can be retrieval execution conditions. Further, it includes specification of an output format style A16, a save destination A21 and a save file name A22 as information which can be retrieval result output conditions like the retrieval request A2 depicted in FIG. 11.

In this case, as an input assistance method which allows a user to specify the retrieval execution period A31, a selection window is presented to the user as described above. Furthermore, as more concrete processing which specifies the retrieval execution period A31, for example, it is possible to execute processing which presents a default value which is preset as a retrieval execution period to a user and determines this default value as a retrieval execution period when a different value is not specified by the user.

In the data server 101, when the retrieval request A3 for new setting transmitted from the user terminal 102 is received through the data retrieval unit 110 (YES at S1311), a retrieval condition setting unit 301 of the data retrieval unit 110 sets retrieval conditions E3 required to periodically execute retrieval based on the retrieval execution period A31 by using various kinds of information included in the retrieval request A3 as retrieval condition setting processing, and saves the retrieval conditions E3 in a retrieval condition database 303 (S1312).

When the retrieval conditions E3 set in accordance with the retrieval request A3 are saved in the retrieval condition database 303, the retrieval condition setting unit 301 creates a response notification D3 including setting result state information indicative of whether the retrieval conditions are normally set or whether the set retrieval conditions are normally saved and returns the created notification to the user terminal 102 which has issued the request as result notification processing (S1313).

When the response notification D3 transmitted from the data server 101 is received in the user terminal 102 which has issued the request (YES at S1303), the retrieval interface 120 outputs setting result state information included in the response notification D3 from an output device 122 as setting result state information output processing (S1304).

Moreover, when information required to issue a retrieval request A3 for setting change is given in the user terminal 102 after the retrieval conditions E3 are once set based on the retrieval request A3 (YES at S1305), the retrieval interface 120 creates the retrieval request A3 for setting change based on this information and transmits it to the data server 101 (S1302).

It is to be noted that such a retrieval request A3 for setting change may be configured to include various kinds of information as shown in FIG. 14. Additionally, when change information required to change some items only, i.e., change information required to change a retrieval execution period only is given, eliminating information concerning items which are not to be changed can reduce a data size of the retrieval request A3.

In the data server 101, when the retrieval request A3 for setting change transmitted from the user terminal 102 is received by the data retrieval unit 110 (YES at S1314), the retrieval condition setting unit 301 in the data retrieval unit 110 changes the setting of the already-set retrieval conditions E3 by using change information included in the retrieval request A3 and saves the updated retrieval conditions E3 in the retrieval condition database 303 as retrieval condition setting change processing (S1312).

The retrieval execution unit 302 in the data retrieval unit 110 executes the same processing as the series of retrieval execution processing (S1012 to S1018) depicted in FIG. 10 as predetermined retrieval execution processing in accordance with each set retrieval execution period A31 (YES at S1315) based on the retrieval conditions E3 saved in the retrieval condition database 303, and saves retrieval result data C3 under a specified file name in a specified file format style at a save destination specified by the retrieval request A3 (S1316).

The retrieval execution unit 302 repeats retrieval execution processing (YES at S1315, and S1316) in accordance with each retrieval execution period A31 as long as there is no deletion request for the retrieval conditions from the user terminal 102 (NO at S1317), and accumulates the retrieval result data C3 at a specified save destination.

Furthermore, when information to issue the deletion request for the already-set retrieval conditions E3 is given from a user through the input device 121 in the user terminal 102 (YES at S1306), retrieval interface means 120 creates the deletion request for the retrieval conditions E3 based on this information, and transmits the created request to the data server 101 through the communication network 103 (S1307).

In the data server 101, when the deletion request for the retrieval conditions E3 transmitted from the user terminal 102 is received by the data retrieval unit 110 (YES at S1317), the retrieval condition setting unit 301 of the data retrieval unit 110 deletes the retrieval conditions E3 saved in the retrieval condition database 303 as retrieval condition deletion processing (S1318).

(Effects of Third Embodiment)

According to the system shown in FIG. 12, in addition to the same effects as those of the system depicted in FIG. 9, the following effects can be additionally obtained.

That is, in the user terminal, a user can specify a retrieval execution period and transmit a retrieval request including the specified retrieval execution period to the data server. As a result, on the data server side, retrieval corresponding to the retrieval request is repeatedly executed in accordance with the retrieval execution period specified by the user, and obtained retrieval result data is saved under a file name specified by the user in a file format style specified by the user at a save destination specified by the user.

Therefore, in a case where a user is going to obtain periodic retrieval result data, when a retrieval request including specification of the retrieval execution period useful for the user is once issued, data retrieval is thereafter automatically repeatedly performed in accordance with the specified retrieval execution period. Consequently, the periodically obtained retrieval result data is automatically saved and stored with a user-friendly file name in an easy-to-use style at a destination which can be readily utilized by the user. Therefore, the user can periodically, assuredly and easily manage the retrieval result data without sequentially issuing the retrieval request in accordance with each retrieval execution period.

[Fourth Embodiment]

(System Configuration)

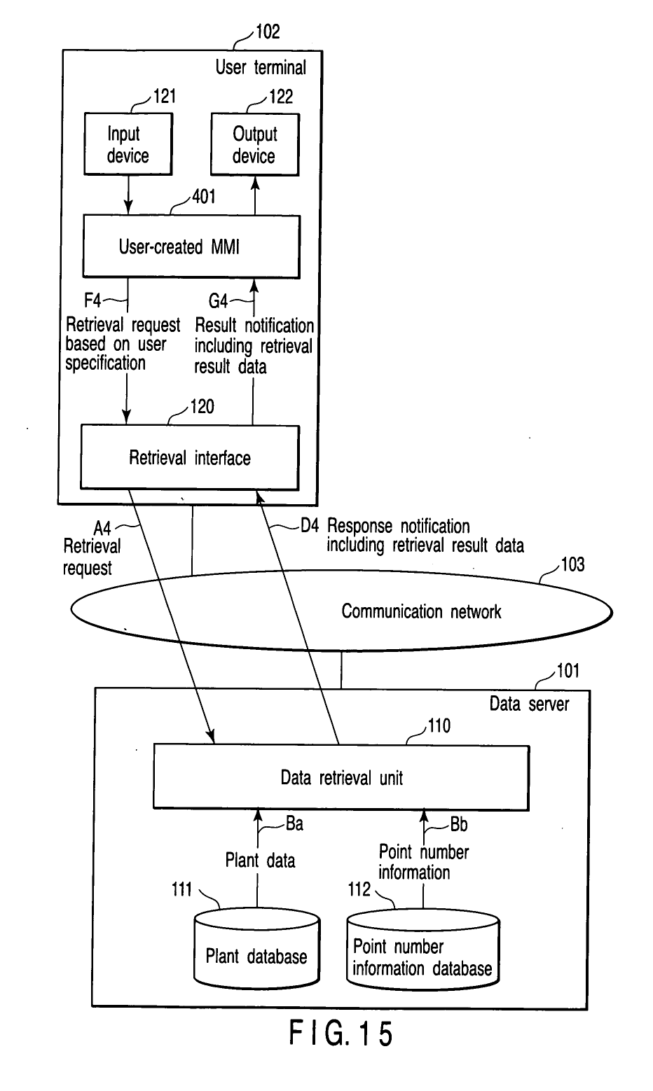

FIG. 15 is a block diagram showing a configuration of a history data management system concerning a fourth embodiment.

The system shown in FIG. 15 corresponds to a modification of the FIG. 1 system, and has a modified configuration and function of the data server 101 in the FIG. 1 system and additionally has a function of the user terminal 102.

This system is configured to accept a retrieval request based on a user specification through a man-machine interface subjected to specification change or created on a user side, execute data retrieval processing in a data server 101 and output retrieval result data desired by a user based on the user specification.

That is, in this system, a retrieval interface 120 in a user terminal 102 accepts a retrieval request F4 based on a user specification given from a user through a man-machine interface (a user-created MMI) 401 created by the user. Further, the retrieval interface 120 is configured to create a retrieval request A4 based on a system specification which can be processed in a data retrieval unit 110 in the data server 101 from information included in this retrieval request F4, and transmit the created request to the data server 101. In this case, the retrieval request F4 based on the user specification and the retrieval request A4 based on the system specification include specification of a retrieval target period, specification of a data class and others as information which can be retrieval execution conditions.

Moreover, the retrieval interface 120 receives a response notification D4 including retrieval result data from the data server 101, creates a result notification G4 including retrieval result data based on the user specification which can be processed in the user-created MMI 401 from the retrieval result data included in the response notification D4, and provides the created result notification G4 to the user-created MMI 401.

The data retrieval unit 110 in the data server 101 executes retrieval based on the retrieval request from the user terminal 102, and returns the response notification D4 including the obtained retrieval result data to the user terminal 102 which has issued the request.

(Processing Procedure)

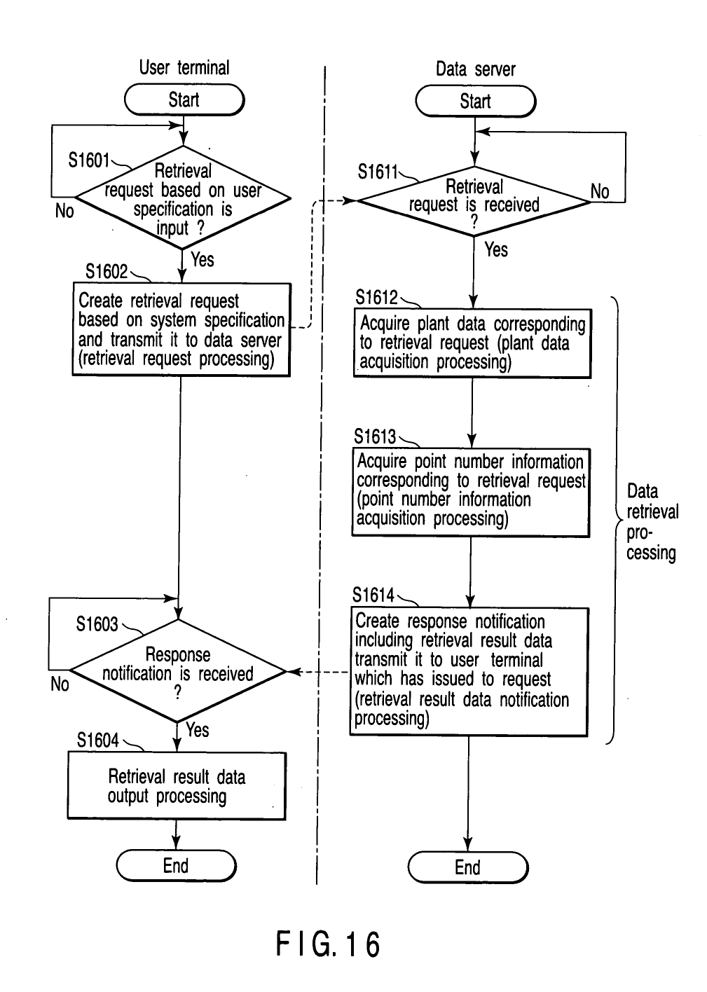

FIG. 16 is a flowchart showing a processing procedure of the system depicted in FIG. 15.

As shown in FIG. 16, when the retrieval request F4 based on the user specification is given by an input device 121 in the user terminal 102 from a user through the user-created MMI 401 (YES at S1601), the retrieval interface 120 creates the retrieval request A4 based on the system specification which can be processed in the data retrieval unit 110 in the data server 101 from information included in this retrieval request F4, and transmits the created retrieval request A4 to the data server 101 through a communication network 103 (S1602).

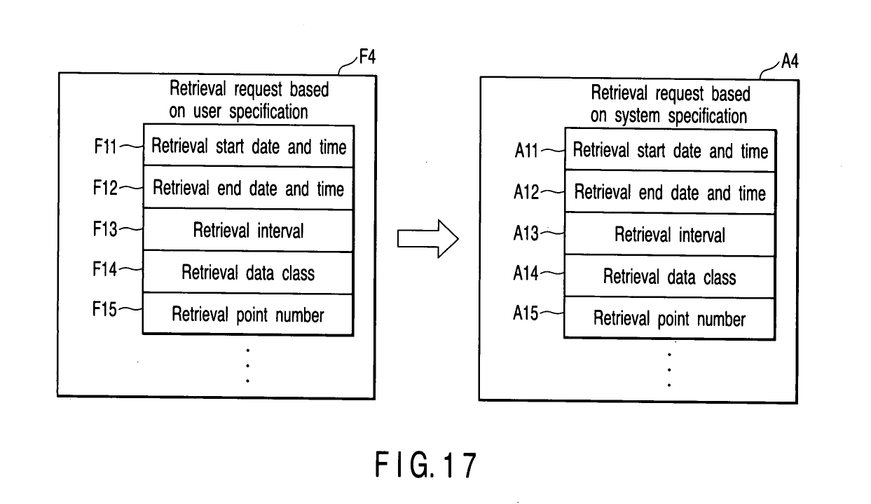

FIG. 17 is a view showing configurations of the retrieval request F4 based on the user specification processed by the retrieval interface 120 as such retrieval request processing and the retrieval request A4 based on the system specification obtained as a processing result.

The retrieval request A4 based on the system specification includes specification of a retrieval start date and time A11, a retrieval end date and time A12, a retrieval interval A13, a retrieval data class A14, a retrieval point number A15 and others as information which can be retrieval execution conditions. The retrieval request F4 based on the user specification includes specification of information F11 to F15 corresponding to such information A11 to A15. Moreover, a concrete description, a transfer arrangement order or the like included in the retrieval request F4 is based on a unique user specification corresponding to the user-created MMI 401, and may include items which are not contained in the retrieval request A4 based on the system specification, e.g., a retrieval request number which identifies each retrieval request. For example, when a description of a retrieval data class differs depending on the user specification and the system specification, the retrieval interface 120 copes with such different descriptions by processing of, e.g., reading them as synonymous descriptions or similar descriptions.

In the data server 101, a procedure from receiving the retrieval request A4 transmitted from the user terminal 102 by the data retrieval unit 110 (YES at S1611) to performing plant data acquisition processing (S1612) and point number information acquisition processing (S1613) is the same as the processing procedure depicted in the flowchart of FIG. 4.

In the system depicted in FIG. 15, after the above-described processing, the data retrieval unit 110 creates the response notification D4 including retrieval result data and retrieval result state information obtained by the plant data acquisition processing and the point number information acquisition processing as retrieval result data notification processing, and returns the created response notification D4 to the user terminal 102 which has issued the request (S1614). In this case, the retrieval result state information is information indicative of, e.g., whether all data corresponding to the retrieval request has been acquired or whether the description has been differently read.

Moreover, in the user terminal 102 which has issued the request, when the response notification D4 including the retrieval result data transmitted from the data server 101 is received by the retrieval interface 120 (YES at S1603), the retrieval interface 120 executes retrieval result data output processing (S1604). That is, the result notification G4 including the retrieval result data based on the user specification which can be processed in the user-created MMI 401 is created from the response notification D4 based on the system specification, provided to the user-created MMI 401, and output from an output device 122.

(Effects of Fourth Embodiment)

According to the system depicted in FIG. 15, the following effects can be obtained.

That is, in the user terminal, a user can issue a retrieval request by using the user-created MMI subjected to specification change or created on the user side. In this case, retrieval corresponding to the retrieval request is performed on the data server side, and its retrieval result data is transmitted to the user terminal which has issued the request, and output through the user-created MMI. Therefore, the user can freely create the user-created MMI which can be readily utilized by the user, and easily issue the retrieval request in which the user's intention is assuredly reflected. As a result, retrieval result data desired by the user can be output based on a most user-friendly specification, and can be readily utilized.

[Fifth Embodiment]

(System Configuration)

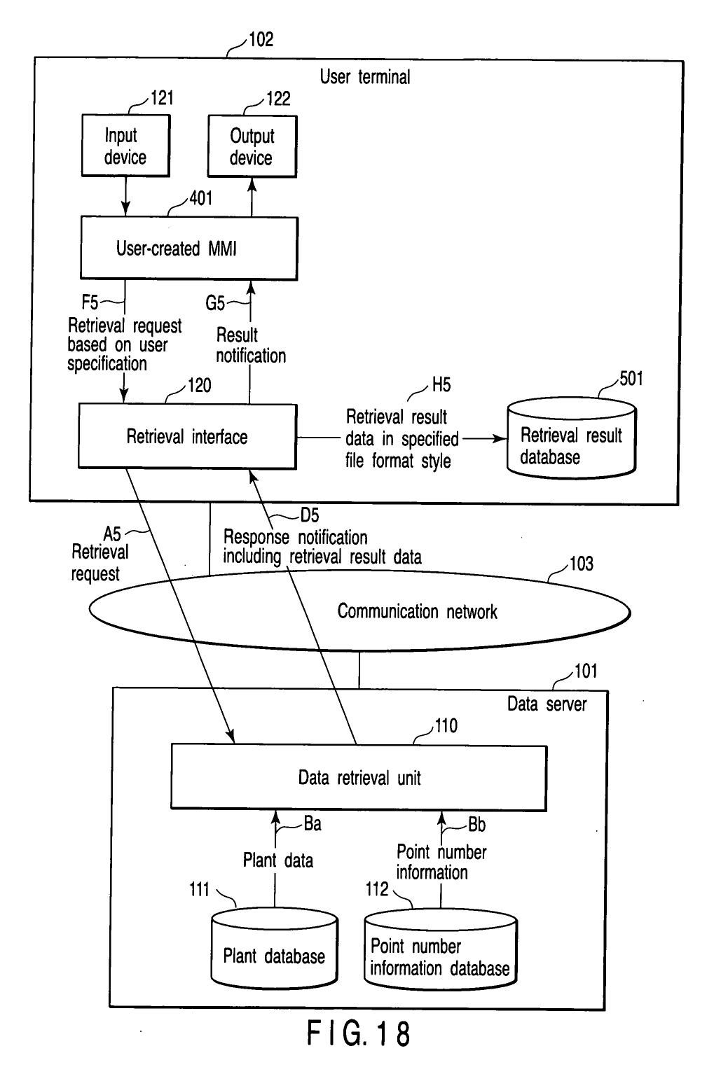

FIG. 18 is a block diagram showing a configuration of a history data management system concerning a fifth embodiment.

The system depicted in FIG. 18 corresponds to a modification of the FIG. 15 system, and additionally has a configuration and a function of the user terminal 102 in the FIG. 15 system. In this system, upon receiving a retrieval request based on a user specification including specification of a file format style at the time of output transmitted through a user-created MMI 401, a data server 101 executes data retrieval processing and saves retrieval result data desired by a user in a specified file format style.

That is, when a retrieval request F5 based on a user specification including specification of a file format style at the time of output is accepted, a retrieval interface 120 creates retrieval result data H5 in a specified file format style from retrieval result data included in a response notification D5 from the data server 101, and saves the created data in a retrieval result database 501 in the user terminal 102. The retrieval interface 120 executes a result notification G5 including retrieval result state information. That is, a retrieval result database 501 is configured at a predetermined fixed save position in the user terminal 120.

(Processing Procedure)

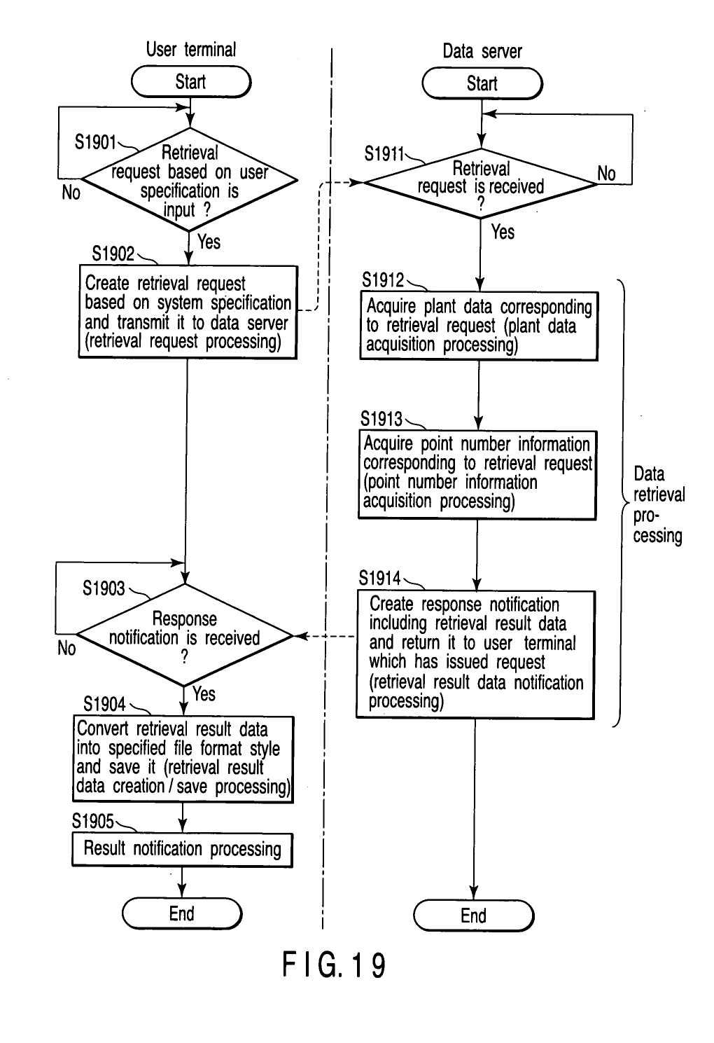

FIG. 19 is a flowchart showing a processing procedure of the system depicted in FIG. 18.

As shown in FIG. 19, when the retrieval request F5 based on a user specification including specification of a file format style at the time of output is given through the user-created MMI 401 by an input device 121 in the user terminal 102 from a user (YES at S1901), the retrieval interface 120 executes retrieval request processing.

That is, the retrieval interface 120 creates a retrieval request A5 based on a system specification excluding information which can be retrieval result output conditions, i.e., specification of a file format style from information included in the retrieval request F5 based on the user specification, and transmits the created request to the data server 101 through a communication network 103 (S1902).

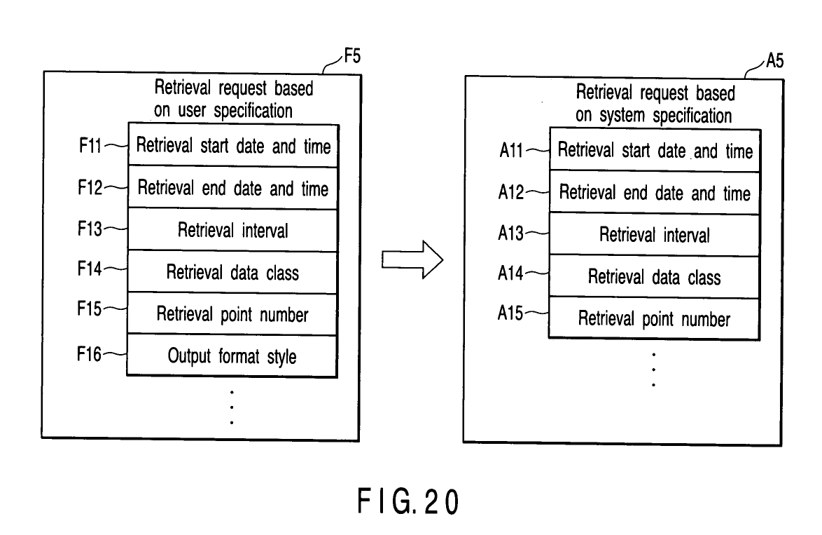

FIG. 20 is a view showing configurations of the retrieval request F5 based on the user specification processed by the retrieval interface 120 as such retrieval request processing and the retrieval request A5 based on the system specification obtained as a processing result.

The retrieval request A5 based on the system configuration includes specification of a retrieval start date and time A11, a retrieval end date and time A12, a retrieval interval A13, a retrieval data class A14, a retrieval point number A15 and others as information which can be retrieval execution conditions. The retrieval request F5 based on the user specification includes specification of information F11 to F15 corresponding to such information A11 to A15 as well as specification of an output format style F16 as information which can be retrieval result output conditions.

In the data server 101, upon receiving the retrieval request A5 transmitted from the user terminal (YES at S1911), the data retrieval unit 110 executes plant data acquisition processing (S1912), point number information acquisition processing (S1913) and retrieval result data notification processing (S1914) as data retrieval processing. This processing procedure is the same as the processing procedure depicted in the flowchart of FIG. 16.

Moreover, when the response notification D5 including retrieval result data transmitted from the data server 101 is received in the user terminal 102 which has issued the request (YES at S1903), the retrieval interface 120 executes retrieval result data creation/save processing (S1904). That is, the retrieval interface 120 converts the retrieval result data included in the response notification D5 based on the system configuration into retrieval result data H5 in the file format style specified in the retrieval request FS based on the user specification, and saves the converted data in a retrieval result database 501 configured at a predetermined fixed save position in the user terminal 102.

The retrieval interface 120 creates a result notification G5 including retrieval result state information contained in the response notification D5 from the data server 101 and retrieval result state information indicating that the retrieval result data H5 is saved in the retrieval result database 501, provides it to the user-created MMI 401 and outputs it by an output device 122 as result notification processing (S1905).

(Effects of Fifth Embodiment)

According to the system shown in FIG. 18, in addition to the same effects as those of the system depicted in FIG. 15, the following effects can be further obtained.

That is, in the user terminal, a user can specify a file format style at the time of.outputting retrieval result data by the user-created MMI subjected to specification change or created on the user side. Transmitting the retrieval request including this specified file format style to the data server effects retrieval corresponding to the retrieval request on the data server side. This retrieval result data is saved in a predetermined retrieval result database in the file format style specified by the user in the user terminal.

Therefore, when a user just specifies a preferable file format style which can be easily used by the user through the user-created MMI, the retrieval result data obtained by retrieval can be automatically saved in a user-friendly style at a predetermined position in the user terminal. Therefore, the user can readily perform secondary data utilization of the retrieval result data without carrying out a change operation for a style of the retrieval result data.

[Sixth Embodiment]

(System Configuration)

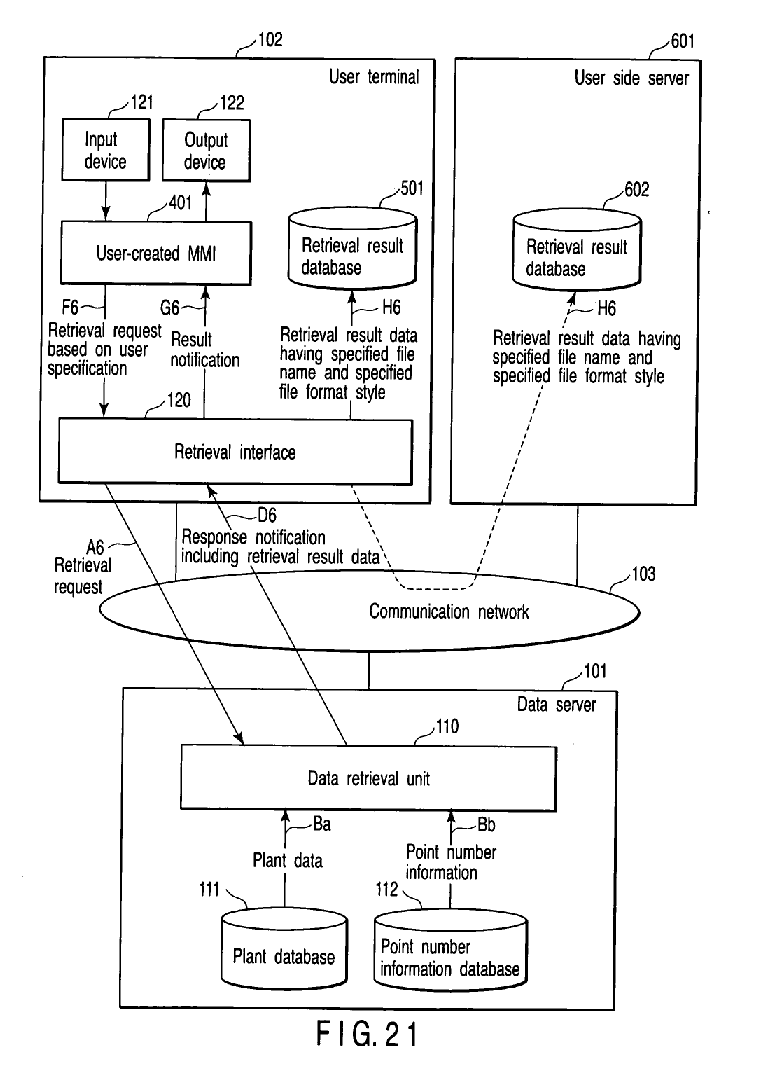

FIG. 21 is a block diagram showing a configuration of a history data management system concerning a sixth embodiment.

The system shown in FIG. 21 is a modification of the system depicted in FIG. 18, additionally has a configuration and a function of the user terminal 102 in the FIG. 18 system and additionally has a user side server 601 connected with a communication network 103.

Here, like the user side server 201 shown in FIG. 9, a user side server 601 is a server in which a user manages data which is utilized for a business including plant data retrieval or a different business, and it is a server dedicated to a single user or a shared server utilized by a plurality of users. A retrieval result database 602 in which retrieval result data H6 is saved is provided in this user side server 601.

It is to be noted that the drawing shows the single user side server 601 alone for simplification and clarification, but the plurality of user side servers 601 which can be utilized by the single user terminal 102 are connected with this user terminal 102, and the retrieval result database 602 is likewise provided.

In this system, a user can specify a save destination of the retrieval result data H6 from the user terminal 102 itself and the plurality of user side servers 601. Additionally, a save file name of the retrieval result data H6 can be freely specified. Further, a retrieval interface 120 of the user terminal 102 is configured to accept a retrieval request F6 based on a user specification including specification of a file format style at the time of output, specification of a save destination and specification of a save file name supplied through a user-created MMI 401.

When the retrieval interface 120 accepts the retrieval request F6 based on the user specification including specification of a file format style, specification of a save destination and specification of a save file format, it creates retrieval result data H6 having the specified file name and the specified file format style from retrieval result data included in a response notification D6 from the data server 101, and saves the created data in the specified save destination. In FIG. 21, the retrieval result data H6 is indicated by an arrow of a broken line in order to represent that an output destination of the retrieval result data H6 differs in accordance with specification of a save destination. Further, the retrieval interface means 120 performs a result notification G6 including retrieval result state information with respect to the user-created MMI 401.

(Processing Procedure)

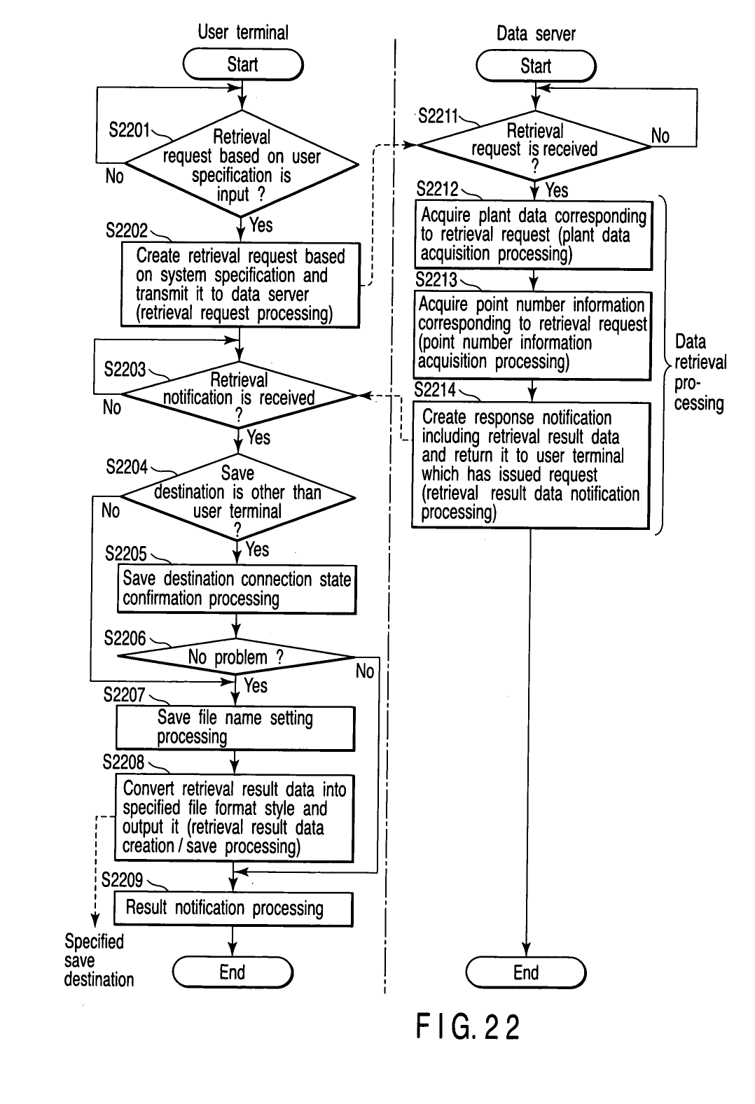

FIG. 22 is a flowchart showing a processing procedure of the system depicted in FIG. 21.

As shown in FIG. 22, when the retrieval request F6 based on a user specification including specification of a file format style, specification of a save destination and specification of a save file name is supplied by an input device 121 in the user terminal 102 from a user through the user-created MMI 401 (YES at S2201), the retrieval interface 120 executes retrieval request processing.

That is, the retrieval interface 120 creates a retrieval request A6 based on a system configuration excluding information which can be retrieval result output conditions, i.e., specification of a file format style, specification of a save destination and specification of a save file name from information included in the retrieval request F6 based on the user specification, and transmits the created request to the data server 101 through the communication network 103 (S2202).

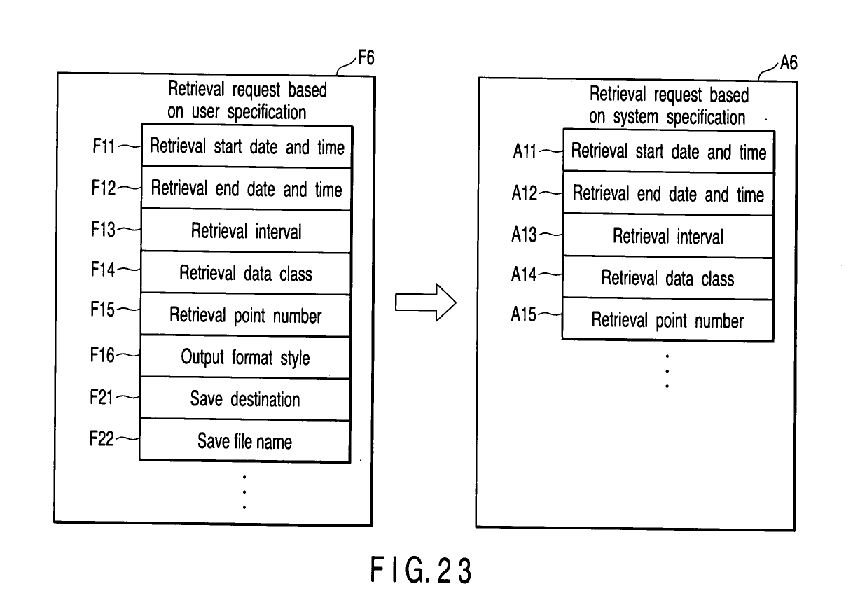

FIG. 23 is a view showing configurations of the retrieval request F6 based on the user specification processed by the retrieval interface 120 as such retrieval request processing and the retrieval request A6 based on the system specification obtained as a processing result.

The retrieval request A6 based on the system specification includes specification of a retrieval start date and time A11, a retrieval end date and time A12, a retrieval interval A13, a retrieval data class A14, a retrieval point number A15 and others as information which can be retrieval execution conditions. The retrieval request F6 based on the user specification includes specification of information Fll to F15 corresponding to such information A11 to A15 as well as specification of an output format style F16, a save destination F21 and a save file name F22 as information which can be retrieval result output conditions.

In the data server 101, a processing procedure of receiving by the data retrieving means 110 the retrieval request A6 transmitted from the user terminal 102 (YES at S2211) and performing plant data acquisition processing (S2212), point number information acquisition processing (S2213) and retrieval result data notification processing (S2214) as data retrieval processing is the same as the processing procedure shown in the flowchart of FIG. 19.

Furthermore, when the response notification D6 including the retrieval result data transmitted from the data server 101 is received in the user terminal 102 which has issued the request (YES at S2203), the retrieval interface 120 judges whether the save destination F21 specified in the retrieval request F6 based on the user specification is other than the user terminal 102 (S2204). Moreover, if the specified save destination F21 is other than the user terminal 102 (YES at S2204), the retrieval interface 120 confirms whether the actual save destination, i.e., the user side server 601 is normally connected with the communication network 103 as save destination connection state confirmation processing (S2205)

If the save destination is normally connected (YES at S2206), the retrieval interface 120 determines the save file name F22 included in the retrieval request F6 based on the user specification as a file name for the retrieval result data H6 which is saved at the save destination as save file name setting processing (S2207). Subsequently, the retrieval interface 120 converts the retrieval result data included in the response notification D6 from the data server into retrieval result data H6 having a file format style specified by the output format style F16 in the retrieval request F6 based on the user specification as retrieval result data creation/save processing. The retrieval interface 120 transmits the retrieval result data H6 to the user side server 601 as the normally connected save destination, and saves this data in the retrieval result database 602 in the user side server 601.

When the retrieval result data H6 is saved in the specified file format style under the specified file name at the save destination specified by the retrieval request F6 based on the user specification in this manner, the retrieval interface 120 creates a result notification G6 including retrieval result state information contained in the response notification D6 from the data server 101 and retrieval result state information indicating that the retrieval result data H6 has been normally saved, provides the created notification to the user-created MMI 401, and outputs it by an output device 122 (S2209).

Moreover, when an actual save destination specified by specification of the save destination F21 is not normally connected (NO at S2206), the retrieval interface 120 creates a result notification G6 including retrieval result state information indicative of a connection defect of the save destination, and provides it to the user-created MMI 401 and outputs it by the output device 122 as result notification processing (S2209).

On the other hand, when the specified save destination F21 is the user terminal 102 itself which has issued the request (NO at S2204), the retrieval interface 120 executes save file name setting processing (S2207), retrieval result data creation/save processing (S2208) and result notification processing (S2209) only.

(Effects of Sixth Embodiment)

According to such a system as shown in FIG. 21, in addition to the same effects as those of the FIG. 18 system, the following effects can be further obtained.

That is, in the user terminal, a user can specify not only a file format style at the time of outputting retrieval result data but also a save destination or a save file name by using the user-created MMI subjected to specification change or created on the user side. As a result, a retrieval request including specification of these items can be transmitted to the data server.

Additionally, retrieval corresponding to the retrieval request is executed on the data server side, and its retrieval result data is saved at a save destination specified by the user under a file name specified by the user in a file format style specified by the user.

Therefore, when a user just specifies a preferable file format style which can be easily utilized by the user as well as a preferable save destination or file name which can be readily utilized by the user through the user-created MMI, the retrieval result data obtained by retrieval is automatically saved at a save destination which can be easily utilized under a file name which can be readily utilized in a user-friendly style. Therefore, the user can assuredly and easily unify the management of the retrieval result data without newly performing a style change operation, a save position change operation, a file name change operation and others. Further, the retrieval result data can be received in the user terminal and output to an arbitrary save destination, the retrieval result data can be saved in an arbitrary save position in a network which is not recognized on the data server side.

(Modification)

It is to be noted that, in regard to the system shown in FIG. 21, the description has been given as to the example where a save destination of retrieval result data is selected from the user terminal 102 itself which has issued the request and the plurality of user side servers 601, but the following configuration will now be explained.

That is, as a modification, a save destination may be selected from not only the user terminal 102 itself which has issued the request and the plurality of user side servers 201 but also many save destinations including a different terminal, a different sever and others connected with the communication network 103.

Further, although the description has been given as to the example where a save destination and a save file name of retrieval result data are specified in the system shown in FIG. 21, it is also possible to specify a save destination only without specifying a save file name, or specify a save file name only without specifying a save destination as a modification.

When a save file name is not specified, there is carried out processing of, e.g., automatically giving a file name based on a predetermined file name setting rule, e.g., a serial number. Furthermore, when a save destination is not specified, there is carried out processing of, e.g., automatically saving retrieval result data at a predetermined save destination in the user terminal itself or the like which has issued the request.

[Seventh Embodiment]

(System Configuration)

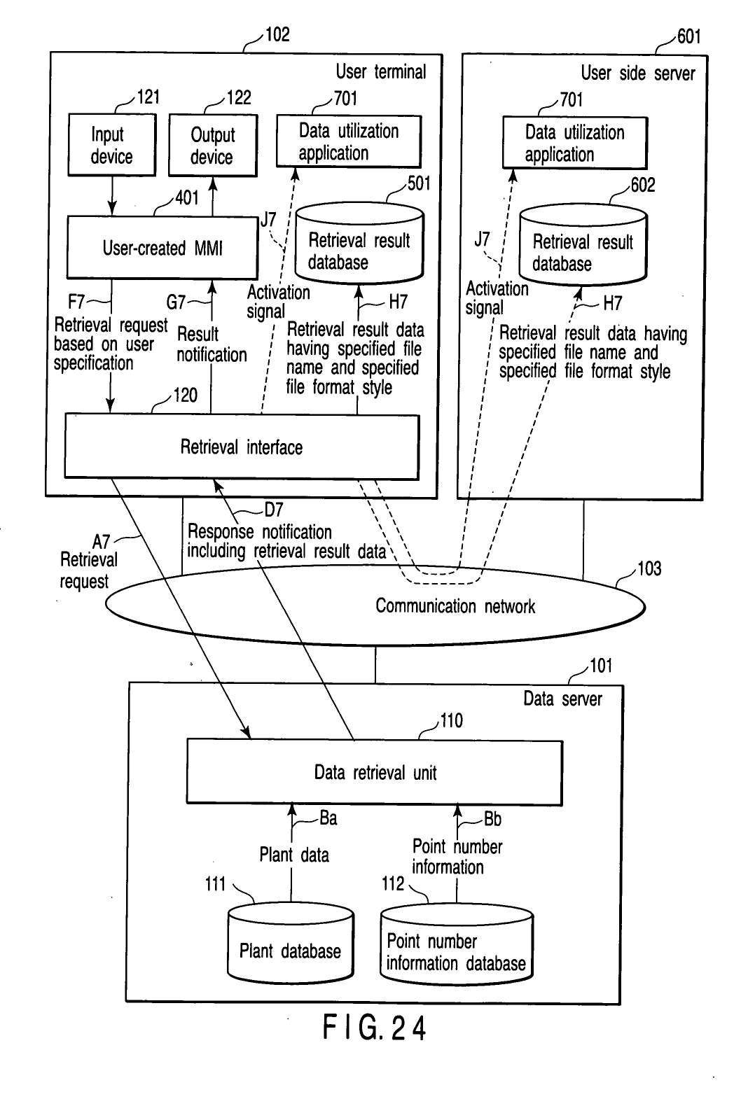

FIG. 24 is a block diagram showing a configuration of a history data management system concerning a seventh embodiment.

The system shown in FIG. 24 corresponds to a modification of the system depicted in FIG. 21, additionally has a configuration and a function of the user terminal 102 in the FIG. 21 system and also additionally has a configuration of the user side server 601.

That is, in this system, the user terminal 102 and the user side server 601 respectively include data utilization applications 701 and 702 for secondary use of retrieval result data. The user terminal 102 and the user side server 601 activate the data utilization applications 701 and 702 at save destinations by using an activation signal J7 from a retrieval interface 120 of the user terminal 102 when retrieval result data H7 is saved. In FIG. 24, the retrieval result data H7 and the activation signal J7 are indicated by arrows of broken lines in order to express that an output destination of the retrieval result data H7 varies and an output destination of the activation signal J7 also varies depending on specification of a save destination in this manner.

(Processing Procedure)

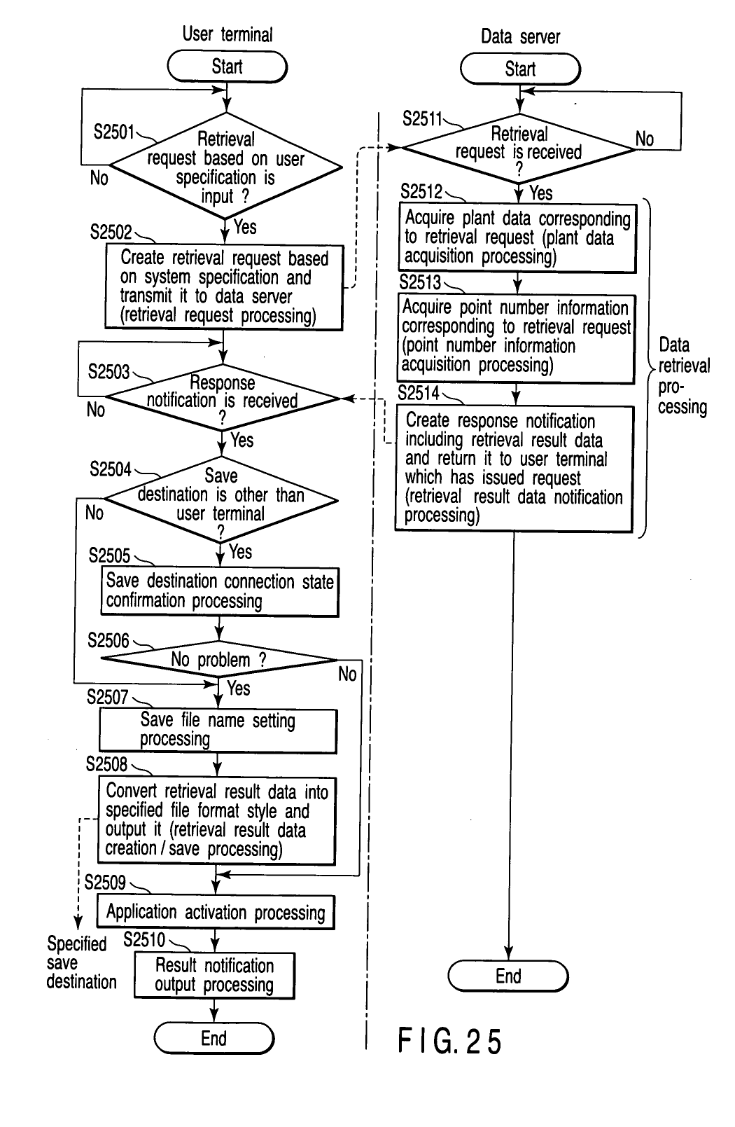

FIG. 25 is a flowchart showing a processing procedure of the system depicted in FIG. 24.

As shown in FIG. 25, when a retrieval request F6 based on a user specification including specification of a file format style, specification of a save destination, specification of a save file name and an activation application name is supplied by an input device 121 in the user terminal 102 from a user through a user-created MMI 401 (YES at S2501), the retrieval interface 120 executes retrieval request processing.

That is, the retrieval interface 120 creates a retrieval request A7 based on a system specification excluding information which can be retrieval result output conditions, i.e., specification of a file format style, specification of a save destination, specification of a save file name and specification of an activation application name from information included in the retrieval request F7 based on the user specification, and transmits the created request to a data server 101 through a communication network 103 (S2502).

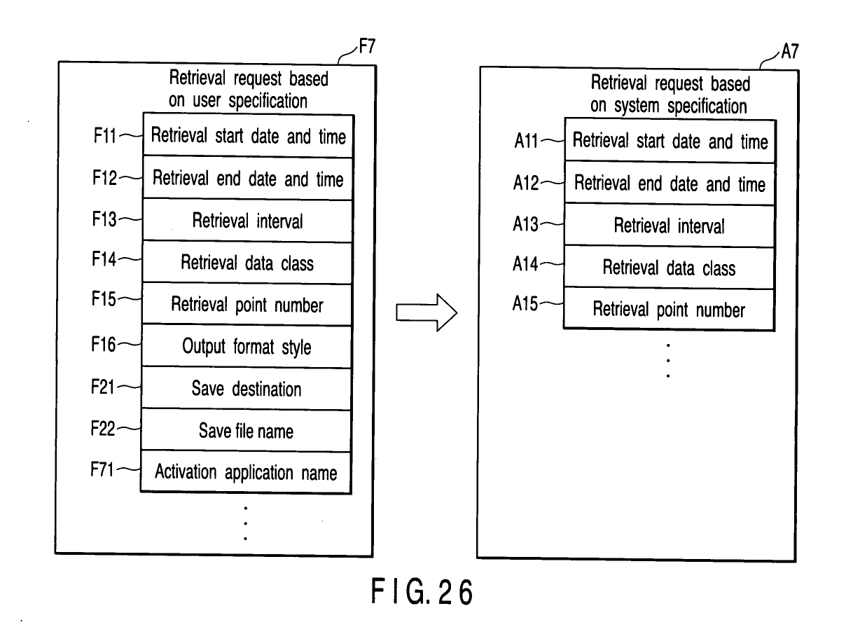

FIG. 26 is a view showing configurations of the retrieval request F7 based on the user specification processed by the retrieval interface 120 as such retrieval request processing and the retrieval request A7 based on the system specification obtained as a processing result.

The retrieval request A7 based on the system specification includes specification of a retrieval start date and time A11, a retrieval end date and time A12, a retrieval interval A13, a retrieval data class A14, a retrieval point number A15 and others as information which can be retrieval execution conditions. A retrieval request F5 based on the user specification includes specification of information F11 to F15 corresponding to such information A11 to A15 as well as specification of an output format style F16, a save destination F21, a save file name F22 and an activation application name F71 as information which can be retrieval result output conditions.

A processing procedure of receiving the retrieval request A7 transmitted from the user terminal 102 by data retrieving means 110 in the data server 101 (YES at S2511) and executing plant data acquisition processing (S2512), point number information acquisition processing (S2513) and retrieval result data notification processing (S2514) as data retrieval processing is the same as the processing procedure shown in the flowchart of FIG. 22.

Moreover, when the retrieval interface 120 in the user terminal 102 which has issued the request receives a response notification D7 including retrieval result data transmitted from the data server 101 (YES at S2503), it executes save destination connection state confirmation processing (S2505) as required (YES at S2504). Subsequently, a processing procedure of executing save file name setting processing (S2507) and retrieval result data creation/save processing (S2508) by the retrieval interface 120 is the same as the processing procedure shown in the flowchart of FIG. 22.

Then, based on an activation application name F71 specified by the retrieval request F7 according to the user specification, the retrieval interface 120 in the user terminal 102 which has issued the request activates an application specified by this name (S2509). That is, when a save destination of the retrieval result data H7 is a retrieval result database 501 in the user terminal 102, the retrieval interface 120 outputs the activation signal J7 to the data utilization application 701 in the user terminal 102 so that the data utilization application 701 is activated by this activation signal J7.

Furthermore, when a save destination of the retrieval result data H7 is a retrieval result database 602 in the user side server 601, the retrieval interface 120 transmits the activation signal J7 to the data utilization application 702 in the user side server 601 so that the data utilization application 702 is activated by this activation signal J7.

When the retrieval result data H7 is saved under a specified file name in a specified file format at a save destination specified by the retrieval request F7 based on the user specification and the specified application is activated in this manner, the retrieval interface 120 normally saves retrieval result state information included in the response notification D7 from the data server 101 and the retrieval result data H7. Moreover, the retrieval interface 120 creates a result notification G7 including retrieval result state information indicating that the application has been normally activated, provides the created notification to the user-created MMI means 401, and outputs it by an output device 122 (S2510).

(Effects of Seventh Embodiment)

According to such a system as shown in FIG. 24, in addition to the same effects as those of the system depicted in FIG. 21, the following effects can be obtained.

That is, in the user terminal, a user can specify not only a file format style at the time of outputting retrieval result data, a save destination or a save file name but also an application which is activated for secondary use by using the user-created MMI subjected to specification change or created on the user side. As a result, the retrieval request including specification of these items can be transmitted to the data server. Moreover, retrieval corresponding to the retrieval request is executed on the data server side, its retrieval result data is saved at a save destination specified by a user under a file name specified by the user in a file format specified by the user, and a specified application is activated.

Therefore, by just specifying an application name required for secondary use of the retrieval result data by the user through the user-created MMI, the application for secondary use of the retrieval result data can be automatically activated when the retrieval result data obtained by retrieval is saved. Thus, the user can readily perform secondary processing of the retrieval result data or special data display of, e.g., a graph or a form by using the activated application.

It is to be noted that the present invention is not restricted to each of the foregoing embodiments, and various conformations can be carried out within the scope of the present invention. For example, it is obvious that appropriately selectively combining the plurality of embodiments can obtain synergic effects corresponding to the combination.

For example, it is possible to consider combining the FIG. 12 system with the FIG. 24 system and issuing a retrieval request including specification of a retrieval execution period through the user-created MMI in the user terminal. In this case, synergic effects of a combination of these systems can be obtained.

Moreover, according to the present invention, since the retrieval result data which is conventionally saved at a fixed save position in a fixed file format under a fixed file name can be saved at a specified position in a specified file format under a specified name, there can be obtained an apparatus in which an intention of a user is reflected. Additionally, secondary use of the retrieval result data is readily enabled.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

1. A system including: a user terminal used by each user; and a data server which stores history data, receives a retrieval request from the user terminal through a communication network, performs retrieval of the history data in response to the received retrieval request and returns a response notification for the retrieval request to the user terminal which has issued the request, the system comprising:
retrieval interface that creates a retrieval request including information which serves as retrieval execution conditions to execute retrieval based on information supplied from the user in the user terminal, transmits the created retrieval request to the data server through the communication network, and receives the response notification for the retrieval request; and
data retrieval unit that retrieves in the data server the history data based on the information which serves as the retrieval execution conditions included in the retrieval request from the user terminal, outputs retrieval result data obtained as a retrieval result to an output destination other than a save position of the history data, and returns the response notification for the retrieval request to the user terminal which has issued the request, wherein the retrieval interface is configured to create as the retrieval request a retrieval request which is classified into at least one of a retrieval request including information which serves as output conditions for the retrieval result data and a retrieval request based on information supplied from the user through man-machine interface created by the user.

2. The system according to claim 1, wherein the retrieval interface is configured to create as the retrieval request a retrieval request including the information which serves as the output conditions,
the data retrieval unit is configured to output the retrieval result data for the retrieval request based on the information which serves as the output conditions included in the retrieval request, and
the information which serves as the output conditions includes one or more types of information selected from specification of a file format style at the time of output, specification of an output destination and specification of an output file name.

3. The system according to claim 2, wherein the retrieval interface is configured to create as the retrieval request a retrieval request including specification of a file format style at the time of output, and
the data retrieval unit is configured to convert the retrieval result data for the retrieval request into a file format style specified by the retrieval request and then output the converted data.

4. The system according to claim 2, wherein the data retrieval unit is configured to determine a save position other than the save position for the history data in the data server as the output destination and save the retrieval result data in the output destination.

5. The system according to claim 3, wherein the data retrieval unit is configured to determine a save position other than the save position for the history data in the data server as the output destination and save the retrieval result data in the output destination.

6. The system according to claim 2, wherein the retrieval interface is configured to create as the retrieval request a retrieval request which includes a position selected from the data server, the user terminal which has issued the request, and a different terminal or a different server connected with the communication network as specification of the output destination, and
the data server is configured to save the retrieval result data in the output destination specified by the retrieval request.

7. The system according to claim 3, wherein the retrieval interface is configured to create as the retrieval request a retrieval request which includes a position selected from the data server, the user terminal which has issued the request, and a different terminal or a different server connected with the communication network as specification of the output destination, and
the data server is configured to save the retrieval result data in the output destination specified by the retrieval request.

8. The system according to claim 2, wherein the retrieval interface is configured to create as the retrieval request as a retrieval request including specification of a file name, and
the data server is configured to save the retrieval result data under the file name specified by the retrieval request.

9. The system according to claim 3, wherein the retrieval interface is configured to create as the retrieval request a retrieval request including specification of a file name, and
the data server is configured to save the retrieval result data under the file name specified by the retrieval request.

10. The system according to claim 1, wherein the data retrieval unit is configured to return the response notification including the retrieval result data as the response notification to the user terminal which has issued the request, and
the retrieval interface is configured to receive the response notification and perform notification concerning the retrieval result data included the response notification with respect to the man-machine interface.

11. The system according to claim 10, wherein the retrieval interface is configured to output the retrieval result data included in the response notification for the retrieval request based on the information which serves as the output conditions when information supplied from the user through the man-machine interface includes the information which serves as the output conditions, and
the information which serves as the output conditions includes one or more types of information selected from specification of a file format style at the time of output, specification of an output destination and specification of an output file name.

12. A method which manages history data by using: a user terminal used by each user; and a data server which stores the history data, receives a retrieval request from the user terminal through a communication network, performs retrieval of the history data in response to the received retrieval request and returns a response notification for the retrieval request to the user terminal which has issued the request, the method comprising:
a retrieval request step of using the user terminal to create a retrieval request including information which serves as retrieval execution conditions to execute retrieval based on information supplied from the user and transmit the created retrieval request to the data server through the communication network;
a data retrieval step of using the data server to perform retrieval of the history data based on the information which serves as the retrieval execution conditions included in the retrieval request from the user terminal, output retrieval result data obtained as a retrieval result to an output destination other than a save position for the history data and return the response notification for the retrieval request to the user terminal which has issued the request; and
a response notification reception step of using the user terminal to receive the response notification for the retrieval request,
wherein the retrieval request step includes a step of creating as the retrieval request a retrieval request which is classified into at least one of a retrieval request including information which serves as output conditions for the retrieval result data and a retrieval request based on information supplied from the user through man-machine interface created by the user.

13. A data server which is used in a system managing history data, stores the history data, receives a retrieval request from a user terminal through a communication network, performs retrieval of the history data in response to the received retrieval request and returns a response notification for the retrieval request to the user terminal which has issued the request, the data server comprising:
data retrieval unit performs retrieval of the history data based on information which serves as retrieval execution conditions included in the retrieval request from the user terminal, outputs retrieval result data obtained as a retrieval result to an output destination other than a save position for the history data, and returns the response notification for the retrieval request to the user terminal which has issued the request,
wherein the data retrieval unit is configured to output the retrieval result data based on information which serves as output conditions for the retrieval result data when the retrieval request includes the information which serves as the output conditions, and
the information which serves as the output conditions includes one or more types of information selected from specification of a file format style at the time of output, specification of an output destination and specification of an output file name.

14. A user terminal device which is used in a system managing history data, transmits a retrieval request to a data server which stores the history data through a communication network, and receives a response notification for the retrieval request from the data server, the user terminal device comprising:
retrieval interface that creates a retrieval request including information which serves as retrieval execution conditions to execute retrieval based on information supplied from a user through man-machine interface means created by the user, transmits the created retrieval request to the data server through the communication network, and receives the response notification for the retrieval request,
wherein the retrieval interface is configured to perform notification concerning retrieval result data obtained as a retrieval result for the retrieval request with respect to the man-machine interface when the response notification includes the retrieval result data.

15. A data server which is used in a system managing history data, stores the history data, receives a retrieval request from a user terminal through a communication network, performs retrieval of the history data in response to the received retrieval request, and returns a response notification for the retrieval request to the user terminal which has issued the request, the data server comprising:
data retrieval unit that performs retrieval of the history data based on information which serves as retrieval execution conditions included in the retrieval request from the user terminal, outputs retrieval result data obtained as a retrieval result to an output destination other than a save position for the history data, and returns the response notification for the retrieval request to the user terminal which has issued the request,
wherein the information which serves as the retrieval execution conditions includes specification of a retrieval execution period in which retrieval of the history data is executed, and
the data retrieval unit is configured to periodically perform retrieval of the history data based on the retrieval execution period specified by the retrieval request.

16. A program executed by a data server which is used in a system managing history data, stores the history data, receives a retrieval request from a user terminal through a communication network, performs retrieval of the history data in response to the received retrieval request, and returns a response notification for the retrieval request to the user terminal which has issued the request, the program having:
a data retrieval step of performing retrieval of the history data based on information which serves as retrieval execution conditions included in the retrieval request from the user terminal, outputting retrieval result data obtained as a retrieval result to an output destination other than a save position for the history data, and returning the response notification for the retrieval request to the user terminal which has issued the request; and
a step of outputting the retrieval result data based on information which serves as output conditions for the retrieval result data when the retrieval request includes the information which serves as the output conditions,
wherein the information which serves as the output conditions includes one or more types of information selected from specification of a file format style at the time of output, specification of an output destination and specification of an output file name.

17. A program executed by a user terminal device which is used in a system managing history data, transmits a retrieval request to a data server which stores history data through a communication network, and receives a response notification for the retrieval request from the data server, the program having:
a step of creating a retrieval request including information which serves as retrieval execution conditions to execute retrieval based on information supplied from a user through man-machine interface means created by the user;
a step of transmitting to the data server through the communication network;
a step of receiving the response notification for the retrieval request; and
a step of executing notification concerning retrieval result data included in the response notification with respect to the man-machine interface means when the response notification includes the retrieval result data obtained as a retrieval result for the retrieval request.

18. A program executed by a data server which is used in a system managing history data, stores the history data, receives a retrieval request from a user terminal through a communication network, performs retrieval of the history data in response to the received retrieval request, and returns a response notification for the retrieval request to the user terminal which has issued the request, the program having:
a step of executing retrieval of the history data based on information which serves as retrieval execution conditions included in the retrieval request from the user terminal;
a step of outputting retrieval result data obtained as a retrieval result to an output destination other than a save position for the history data;
a step of returning the response notification for the retrieval request to the user terminal which has issued the request; and
a step of periodically executing retrieval of the history data based on a retrieval execution period specified by the retrieval request, the information which serves as the retrieval execution conditions including specification of the retrieval execution period in which retrieval of the history data is executed.
